(19) United States
(12) Patent Application Publication
(10) Pub. No.: US 2017/0240413 A1
(43) Pub. Date: Aug. 24, 2017

(54) Desktop Water Bottle Dispenser

(71) Applicant: Kenneth John Gallagher, Las Vegas, NV (US)

(72) Inventor: Kenneth John Gallagher, Las Vegas, NV (US)

(21) Appl. No.: 15/334,282

(22) Filed: Oct. 25, 2016

Related U.S. Application Data
(63) Continuation-in-part of application No. 15/047,208, filed on Feb. 18, 2016, now Pat. No. 9,573,798.

(51) Int. Cl. B67D 3/00; B67D 3/02; B67D 3/04

(52) U.S. Cl. CPC B67D 3/0035; B67D 3/0096; B67D 3/043; B67D 3/02; B67D 3/0083

(57) ABSTRACT

A dispenser base for delivering liquid from a supply bottle has a dispenser base foot. A support member attaches to the dispenser base foot. A second support member attaches to the dispenser base foot. The support members extend upward from the dispenser base foot. A rim for supporting the supply bottle inverted and positioned within the rim is attached to the support members at a location above the dispenser base foot. A lamp fixture, a support device for securing a piercing tool, a retaining device having a threaded cylinder for securing a piercing tool and a bottle cap of the supply bottle, a bottle collar, and a self-powered light engage the dispenser base.

### CROSS REFERENCE TO RELATED APPLICATIONS

This application is a continuation-in-part of application Ser. No. 15/047,208 filed on 2016 Feb. 18, entitled “DESKTOP WATER BOTTLE DISPENSER” in the name of Kenneth J. Gallagher, the entire content of which is incorporated herein by reference.

### BACKGROUND OF THE DISCLOSURE

The present application generally relates to a bottled water dispenser, and, more particularly, to water bottle holders and water bottle dispensers that provide a convenient and simplified mechanism to access bottled water in a direct manner.

With the advent of increased popularity of bottled spring water and bottled purified water here and abroad, a need may have developed for water bottle holders and water bottle dispensers that may provide a convenient and simplified mechanism to access bottled water. In the past, water may have been dispensed through a water crock or similar devices. Water crocks may be jars or containers that store water. A dispensing device may be located at the bottom of the water crock for releasing water stored within the container. Water crocks generally require filling prior to usage and generally need to be cleaned periodically. Water dispensers have evolved from the simple water crocks to bottled water dispensers ranging from the original multiple gallon glass jugs that were inverted and positioned within large free standing and often refrigerated water coolers to the more current, disposable plastic bottles and single use “gallon” plastic water jugs.

A limited number of companies of companies offer purified and spring water in countertop plastic water jug dispensers. These plastic water jug dispensers may typically require that the dispensers lay flat on the countertop, and a single use valve may be located at the bottom of the jug. Of the few brands that do offer a countertop dispenser version of their product, several problems may be associated with their dispensers. To begin with, the user generally needs to administer a vent hole in these dispensers. Unfortunately, these plastic water jug dispensers generally do not provide a piercing tool for this task. Furthermore, the single use valves that are offered with the small number of branded countertop dispensers that are on the market may be of a low quality and may often leak. Lastly, these dispensers may present a number of practical placement and use restrictions and problems.

Over the years, a variety of U.S. patents have issued on dispensing valves/valve parts, and water dispensing devices. U.S. Pat. No. 4,293,082 issued to Shinji Matsueda shows one way in which an inverted bottle can be supported by a stand that includes a thermal insulator for the inverted bottle. U.S. Pat. No. 5,123,720 issued to Blomster et al. discloses a floor based inverted water bottle stand for a 5 gallons bottle. As with the Shinji patent, the Bolomster et al. is patenting the stand that supports an inverted bottle. U.S. Pat. No. 5,647,416 issued to Desrosiers et al. discloses another patent on a stand for a 5 gallons bottle that includes a reservoir and the support housing for the reservoir.

U.S. Pat. No. 6,241,126 issued to Andrew Goodman discloses a personal beverage desktop dispenser with a cubical base and valve housed therein. The male bottle threads are mated with the female threads of the base. An issue with this embodiment is that it may be difficult to invert the entire dispenser to union it with the upright bottle since the bottle valve is secured to the base. Even if the valve was not secured to the base, the valve with the handle is too large to fit through the bottle hole in the base top. It could prove rather difficult to threadably secure an entire base onto a bottle. Moreover, the base could become unsanitary rather quickly having liquid spilled within the base and it appears to be rather difficult to clean.

U.S. Pat. No. 6,527,145 issued to Jules G. Bennett, Jr. discloses a personal desktop beverage dispenser that has a base holding an inverted bottle with the bottle male threads threadably secured to the female threads of the dispenser base. An outflow valve controls the flow of bottle contents to a cup placed beneath. While this embodiment can be used with more than one bottle size it requires having to invert the entire base and threadably secure it onto an upright bottle, which could prove to be rather difficult.

U.S. Pat. No. 6,892,903 issued to Salvatore Barolotta discloses a personal beverage bottle dispenser. The personal beverage bottle dispenser requires that the entire base be inverted and threadably secured to the upright bottle in order to union the bottle with the valve.

U.S. Pat. No. 3,104,089 issued to Harold O. Seltsam, shows a self-closing lift type faucet adapted for use with water crocks, certain coolers, and beverage dispensers. Similarly, U.S. Pat. No. 3207,472 issued Sep. 25, 1965 to Seltsam shows a tubular diaphragm valve. As with the self-closing valve, this valve is again configured for use with water crocks, certain coolers, and beverage dispensers.

### SUMMARY OF THE DISCLOSURE

In accordance with one embodiment, a dispenser base for delivering a liquid from a supply bottle is disclosed. The dispenser base has a dispenser base foot. A support member is attached to the dispenser base foot. A second support member is attached to the dispenser base foot. The support members extend upward from the dispenser base foot. A rim for supporting the supply bottle inverted and positioned within the rim is attached to the support members at a location above the dispenser base foot. A fixture stem is engaged to the dispenser base and extends upwards from the dispenser base. A lamp fixture is attached to the fixture stem. An illumination source is in the lamp fixture. A source of electrical power is in communication with the illumination source.

In accordance with one embodiment, a dispenser base for delivering a liquid from a supply bottle is disclosed. The dispenser base has a dispenser base foot. A support member is attached to the dispenser base foot. A second support member is attached to the dispenser base foot. The support members extend upward from the dispenser base foot. A rim for supporting the supply bottle inverted and positioned within the rim is attached to the support members at a location above the dispenser base foot. A support device engages the dispenser base. The support device is used for supporting and securing a piercing tool to the dispenser base. The piercing is used to administer a vent hole in the supply bottle.

In accordance with one embodiment, a dispenser base for delivering a liquid from a supply bottle is disclosed. The dispenser base has a dispenser base foot. A support member is attached to the dispenser base foot. A second support member is attached to the dispenser base foot. The support members extend upward from the dispenser base foot. A rim for supporting the supply bottle inverted and positioned within the rim is attached to the support members at a location above the dispenser base foot. A bottle collar engages with the rim and is adapted to engage and support the supply bottle inverted and positioned within the rim. The bottle collar has a center aperture where a mouth of the supply bottle extends through. A top enclosure of the bottle collar is formed to engage the supply bottle. The top enclosure surrounds a portion of a sidewall of the supply bottle. The top enclosure restricts a lateral movement of the supply bottle inverted and positioned within the top enclosure. A bottle seat of the bottle collar is formed to removably engage the supply bottle. The bottle seat has the center aperture where the mouth of the supply bottle extends through when the supply bottle is inverted and positioned on the bottle seat. An outer portion of the bottle collar formed to be engaged upon the dispenser base.

In accordance with one embodiment, a dispenser base for delivering a liquid from a supply bottle is disclosed. The dispenser base has a dispenser base foot. A support member is attached to the dispenser base foot. A second support member is attached to the dispenser base foot. The support members extend upward from the dispenser base foot. A rim for supporting the supply bottle inverted and positioned within the rim is attached to the support members at a location above the dispenser base foot. A fixture stem is engaged to the dispenser base and extends upwards from the dispenser base. A self-powered light is attached to the fixture stem.

In accordance with one embodiment, a bottle collar for use with a dispenser base is disclosed. The dispenser base is used for delivering a liquid from an inverted supply bottle. The dispenser base has a dispenser base foot, a support member, and a rim. A top enclosure of the bottle collar surrounds a portion of a sidewall of the inverted supply bottle and restricts a lateral movement of the inverted supply bottle positioned within the top enclosure. A bottle seat of the bottle collar merges with the top enclosure and is formed to removably engage the inverted supply bottle. The bottle seat has a center aperture where a mouth of the inverted supply bottle extends through when the inverted supply bottle is positioned upon the bottle seat. An outer portion of the bottle collar merges with the bottle seat and formed to be removably engaged upon the rim. A bottom ring of the bottle collar merges with the outer portion and is formed to restrict a lateral movement of the bottle collar upon the rim of the dispenser base.

### BRIEF DESCRIPTION OF THE DRAWINGS

In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective front and rear view of an exemplary water bottle dispenser in accordance with one aspect of the present application;

FIG. 2 is a perspective side view of an exemplary dispenser valve used with the exemplary water bottle dispenser in accordance with one aspect of the present application;

FIG. 3 is a perspective side view of the exemplary dispenser valve depicted in FIG. 2 connected to a water bottle in accordance with one aspect of the present application;

FIG. 4—is an exploded view of the exemplary dispenser valve connected to a water bottle of FIG. 3 in accordance with one aspect of the present application;

FIG. 5 is a top view of the exemplary dispenser valve of FIG. 2 in accordance with one aspect of the present application;

FIG. 6 is a sectional view of the exemplary dispenser valve shown in FIG. 5 taken at the sectioning plane in the direction indicated by section lines 6-6 in accordance with one aspect of the present application;

FIG. 7 is a broken orthogonal side view of the exemplary dispenser valve of FIG. 2 in accordance with one aspect of the present application;

FIG. 8 is a broken orthogonal side view of the exemplary dispenser valve of FIG. 2 in accordance with one aspect of the present application;

FIG. 9 is broken orthogonal side view illustrating exemplary dispenser valve of FIG. 2 in accordance with one aspect of the present application;

FIG. 10 is a sectional view of FIG. 9 taken at the sectioning plane in the direction indicated by section lines 10-10 in accordance with one aspect of the present application;

FIG. 11—is a perspective front and rear view of an exemplary water bottle dispenser in accordance with one aspect of the present application;

FIG. 12—is an exploded view of FIG. 11 in accordance with one aspect of the present application;

FIG. 13—is an orthogonal side view of an exemplary dispenser base in accordance with one aspect of the present application;

FIG. 14—is an orthogonal rear view of an exemplary support member of the exemplary dispenser base;

FIG. 15—is a sectional view of the exemplary dispenser base of FIG. 13 taken at the sectioning plane in the direction indicated by section lines 15-15 in accordance with one aspect of the present application;

FIG. 16—is a sectional view of the exemplary dispenser rim of FIG. 13 taken at the sectioning plane in the direction indicated by section lines 16-16 in accordance with one aspect of the present application;

FIG. 17—is an orthogonal bottom view of the exemplary dispenser base of FIG. 13, in accordance with one aspect of the present application;

FIG. 18—is a sectional view of the exemplary dispenser base of FIG. 13 taken at the sectioning plane in the direction indicated by section lines 18-18 in accordance with one aspect of the present application;

FIG. 19—is an orthogonal side view of the exemplary dispenser base in accordance with one aspect of the present application;

FIG. 20—is an orthogonal side view of the exemplary dispenser base in accordance with one aspect of the present application;

FIG. 21—is a sectional view of the exemplary dispenser base of FIG. 20 taken at the sectioning plane in the direction indicated by section lines 21-21, and an exemplary water bottle in accordance with one aspect of the present application;

FIG. 22—is an exploded view of the exemplary dispenser base, a piercing tool support device and a retaining device, in accordance with one aspect of the present application;

FIG. 23—is a perspective front and rear view of the exemplary water bottle dispenser, the exemplary piercing tool support device, and the retaining device in accordance with one aspect of the present application;

FIG. 24—is an exploded view of the exemplary dispenser base, an exemplary fixture stem, and an exemplary lamp fixture assembly, in accordance with one aspect of the present application;

FIG. 25—is an exploded view of the exemplary dispenser base, the exemplary fixture stem, and the exemplary lamp fixture assembly in accordance with one aspect of the present application;

FIG. 26—is a perspective front and rear view of the exemplary dispenser base, the exemplary fixture stem, and the exemplary lamp fixture in accordance with one aspect of the present application;

FIG. 27—is a perspective front and rear view of the exemplary water bottle dispenser, and exemplary fixture stem, and the exemplary lamp fixture in accordance with one aspect of the present application.

FIG. 28—is a perspective front and rear view of the exemplary water bottle dispenser, the exemplary fixture stem, the exemplary support device assembly, and the exemplary lamp fixture in accordance with one aspect of the present application;

FIG. 29—is a perspective view of an exemplary bottle collar in accordance with one aspect of the present application;

FIG. 30—is an orthogonal top view of the exemplary bottle collar and an exemplary rim section in accordance with one aspect of the current application;

FIG. 31—is a sectional view of the exemplary bottle collar of FIG. 30, taken at the sectioning plane in the direction indicated by section lines 31-31 in accordance with one aspect of the present application;

FIG. 32—is an exploded view of the exemplary bottle, the exemplary bottle collar and the exemplary rim section of FIG. 31 in accordance with one aspect of the present application;

FIG. 33—is a perspective view of an exemplary bottle, the exemplary bottle collar, and the exemplary rim section in accordance with one aspect of the present application;

FIG. 34 is a perspective view of an exemplary bottle union used with the exemplary water bottle dispenser in accordance with one aspect of the present application;

FIG. 35 is a perspective view of an exemplary bottle union used with the exemplary water bottle dispenser in accordance with one aspect of the present application;

FIG. 36 is a perspective view of an exemplary bottle union used with the exemplary water bottle dispenser in accordance with one aspect of the present application;

FIG. 37 is a perspective view of an exemplary bottle union used with the exemplary water bottle dispenser in accordance with one aspect of the present application;

FIG. 38—is a perspective front and rear view of the exemplary water bottle dispenser, the exemplary fixture stem, and an exemplary self-powered light in accordance with one aspect of the present application;

FIG. 39—is a perspective front and rear view of the exemplary water bottle dispenser, the exemplary fixture stem, and an exemplary flashlight hook attachment in accordance with one aspect of the present application.

### DETAILED DESCRIPTION OF THE DISCLOSURE

The description set forth below in connection with the appended drawings is intended as a description of presently preferred embodiments of the disclosure and is not intended to represent the forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that also are intended to be encompassed within the spirit and scope of this disclosure.

Accordingly, there are one or more aspects to the present water bottle dispenser that offers advantages over the current existing methods that are being used to serve people water. Embodiments of the disclosure provide a water bottle dispenser that may allow water to be accessed directly from single use water bottles for use with the water bottle dispenser, with no transfer of water to a container required. In accordance with one embodiment, the dispenser provides a lamp fixture attached to the dispenser base. The lamp fixture may enable illumination of the water bottle upon the dispenser so that the dispenser may be found in a dark environment. Additionally, the illuminated water bottle might serve as a night light in an otherwise dark environment.

In accordance with one embodiment, the water bottle dispenser may reduce the problem of not having a tool to administer a vent hole in the supply bottle. The bottle dispenser may provide a retaining device having a threaded cylinder attached to the bottle dispenser. A piercing tool for administering the vent hole the supply bottle may be stored in a threaded cylinder of the retaining device. Once the vent hole is administered in the supply bottle, the piercing tool may be placed back in the threaded cylinder where it stored so that it is available for use to vent the next supply bottle that may be used with the water bottle dispenser. A bottle cap of the supply bottle may be threadably secured to the threaded cylinder of the retaining device. Thus the retaining device may serve as a retainer for the bottle cap of the supply bottle that is used with the water bottle dispenser, and may prevent the bottle cap from being lost. In accordance with one embodiment the dispenser may provide a support device. The support device may support a piercing tool that may be releasably engaged thereto with a magnet. The piercing tool may quickly be accessed to administer a vent hole the inverted water bottle. Once a vent hole is administered in the bottle, the piercing tool may be placed back on the support device where it is magnetically engaged thereto, so that it is available for use to vent the next water bottle that may be used with the water bottle dispenser.

In accordance with one embodiment, the dispenser may provide a removable dispenser valve. The dispenser valve may be threadably coupled to an upright supply bottle. The installation of the dispenser valve onto the upright supply bottle may be simple as only the valve is required to be coupled to the supply bottle. The dispenser valve may control the flow of water for the supply bottle.

Lastly, the dispenser valve may be an improvement over the “one-off” dispenser valves that are commonly used with countertop dispensers, so the quality and life of the dispenser valve may be better, and the dispenser valve may be less likely to leak. The above advantages of one or more aspects of the water bottle dispenser will become apparent upon reflection of the disclosure set forth below.

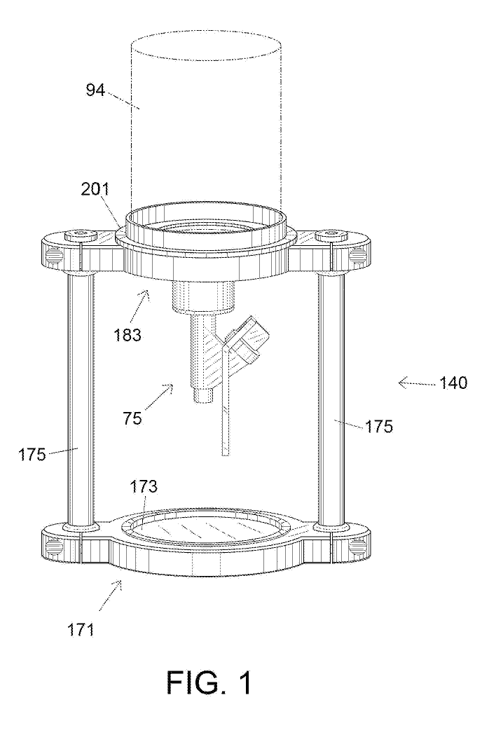

Referring to FIG. 1, a perspective front and rear view (the front and rear views of the dispenser may be identical) of a water bottle dispenser (hereinafter dispenser) is shown. The dispenser may have a dispenser base 140. In the present embodiment a portion of a foot 171, and a portion of a rim 183 of the dispenser base 140 may be circular in shape. However only one example is illustrated, and the foot 171 and the rim 183 may be offered in a variety of different shapes, sizes and configurations. The foot 171 may have a receiving disc 173, however the foot 171 may be formed without the receiving disc 173. As shown in FIG. 1, the dispenser may have a support member 175. As may be shown in FIG. 1, the dispenser may have a second support member 175. However, additional support members 175 could be attached to the base 171 to support the rim 183, and the dispenser could have a plurality of 3 or more support members. The support members 175 may be round, however as with the foot 171 and the rim 183, the support members 175 may also be offered in shapes and sizes other than illustrated. The dispenser base 140 may have a bottle collar 201. The dispenser base 140 and the bottle collar 201 may be constructed of a metal, or a combination of a metal and a durable plastic such as polypropylene. The bottle collar 201 may be removably engaged upon a rim 183. The bottle collar 201 may be used to engage a water supply bottle 94 (hereinafter supply bottle 94) with a circular body inverted and positioned within the rim 183 of the dispenser base 140. A dispenser valve 75 may be coupled to the supply bottle 94. The dispenser valve 75 may control a flow of water (hereinafter liquid) from the supply bottle 94.

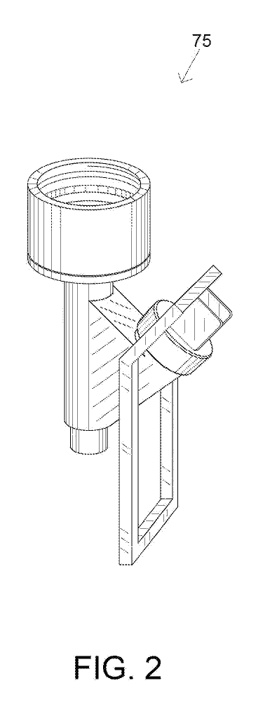

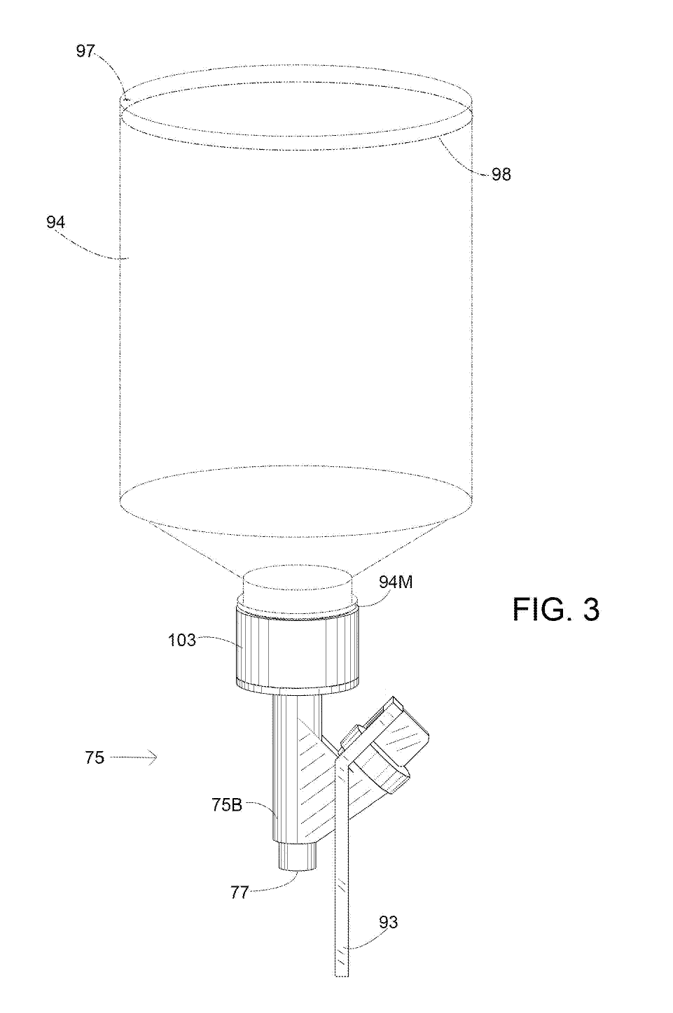

Referring to FIGS. 2 and 3, in accordance with one embodiment the dispenser valve 75 is a removable dispenser valve. As may be shown in FIG. 3, the dispenser valve 75 may be removably coupled to the mouth 94M of the supply bottle 94 with a bottle union 103. The dispenser valve 75 may control a flow of a liquid from the supply bottle 94. The dispenser valve 75 is generally not vented, and may require that prior to usage, a vent hole 97 be administered to the supply bottle 94 in order for liquid to flow adequately through dispenser valve 75 and out of a valve body outlet port 77 (hereinafter outlet port 77) when a valve activation lever 93 is activated. When coupled to the supply bottle 94, the dispenser valve 75 may allow for the transfer of a predetermined amount of liquid from the supply bottle 94 into the dispenser valve 75. This transfer of liquid may drop a liquid level 98 in the supply bottle 94 to a predetermined level. The dropped liquid level may allow for the vent hole 97 to be administered to the supply bottle 94 without the liquid in the supply bottle 94 escaping through vent hole 97.

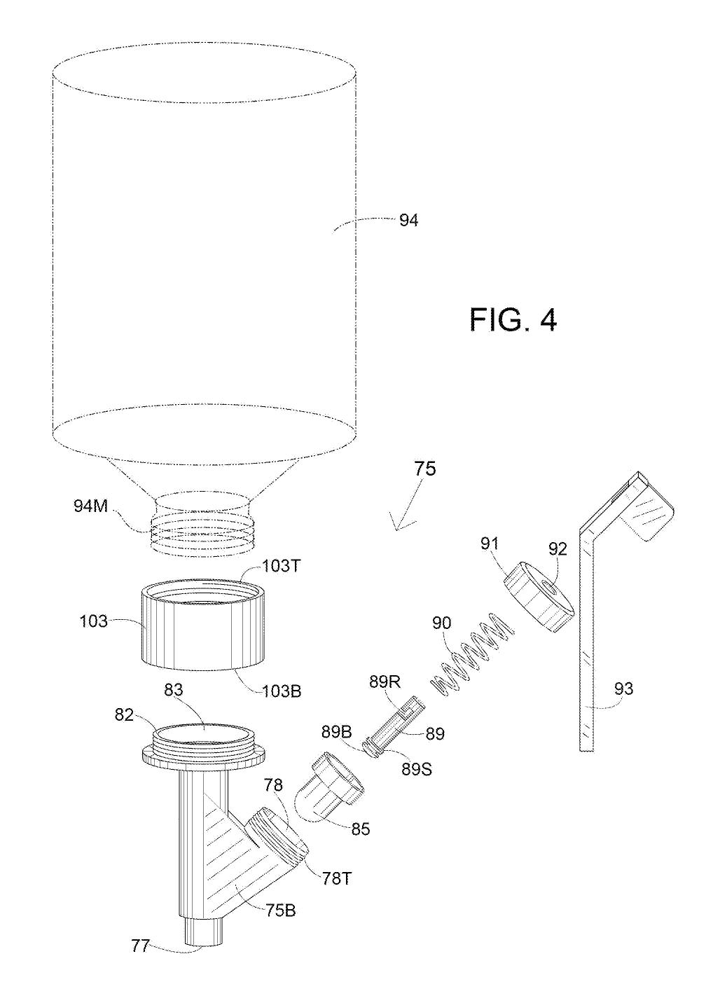

Referring to FIG. 4, and an exploded view of FIG. 3 may be seen. In FIG. 4, the supply bottle 94 and the dispenser valve 75 are illustrated. A union bottom 103B of the bottle union 103 may be threadably secured to a valve body inlet port top 82, and a bottle mouth 94M of the supply bottle 94 may be threadably secured to a bottle union top 103T of bottle union 103. A valve body inlet port 83 (hereinafter inlet port 83), a reservoir 81, and the outlet port 77 of a valve body 75B may be in liquid communication with one another. The outlet port 77 of the valve body 75B may be formed in alignment with the inlet port 83. The outlet port 77 may be located directly below the inlet port 83 when the dispenser valve 75 is coupled to the mouth 94M of the supply bottle 94, and supply bottle 94 is inverted. A component compartment 78, a rubber seat cup 85, and a peg base 89B of a peg 89 may be seen. The peg base 89B may anchor into the seat cup 85. A spring base 89S is where a coil spring 90 may rest when the dispenser valve 75 is assembled. A right pin slot 89R of peg 89 may be seen. The peg 89 may fit inside of the coiled spring 90. A peg aperture 92 of a component compartment bonnet 91 may be seen. Component compartment bonnet 91 may force up against the coil spring 90 when dispenser valve 75 is fully assembled. The peg aperture 92 of component compartment bonnet 91 may be where peg 89 passes through component compartment bonnet 91 so that peg 89 can attach to valve activation lever 93. Component compartment bonnet 91 may be threadably secured onto a threaded component compartment top 78T.

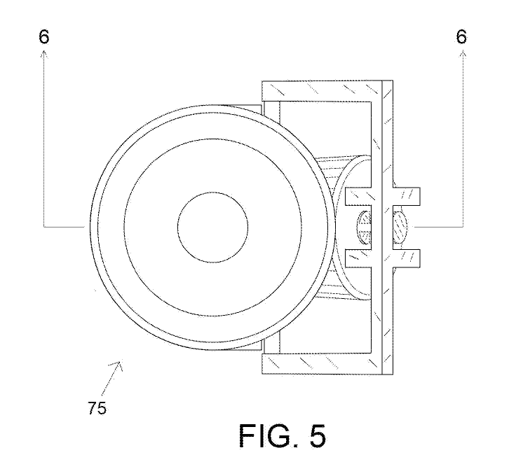

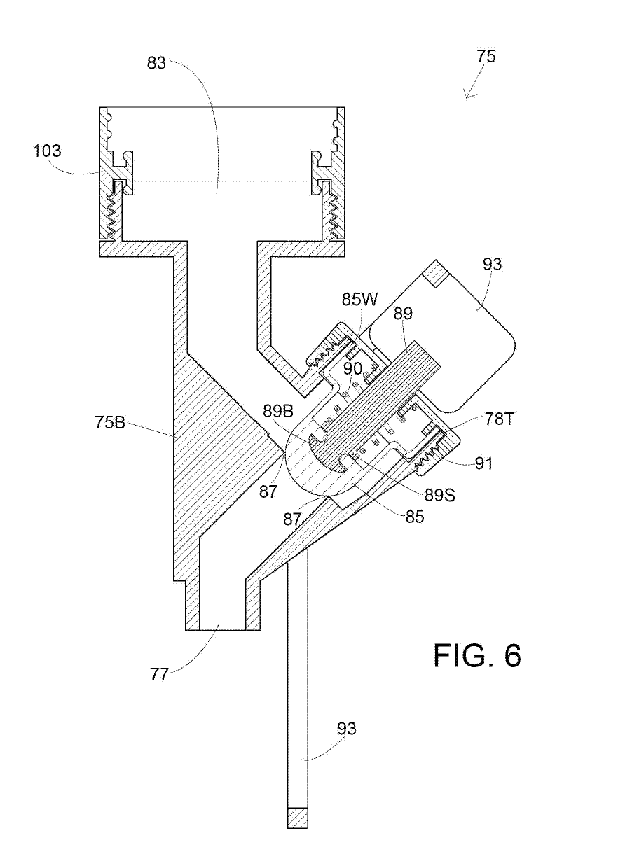

Referring to FIGS. 5 and 6, wherein FIG. 5 is an orthogonal top view of the dispenser valve 75 of FIG. 2 and FIG. 6 is sectional view taken along section lines 6-6 of FIG. 5, the bottle union 103 may be attached to the dispenser valve 75. The valve activation lever 93 may move the peg base 89B, which moves the seat cup 85 upward by pulling the peg 89 further to the outside of the component compartment bonnet 91 when the valve activation lever 93 is activated. The coil spring 90 may rest on the spring base 89S of the peg 89, and push up against the component compartment bonnet 91 which may urge the seat cup 85 downward against a sealing seat 87 when the valve activation lever 93 is in a resting position as may be seen. The sealing seat 87 may be in liquid communication with the inlet port 83, and the outlet port 77. The component compartment bonnet 91 may be contiguous with the seat cup wall 85W to prevent any liquid leakage, and may be threadably secured onto the component compartment top 78T. The valve reservoir 81 and the outlet port 77 as discussed above may also be seen.

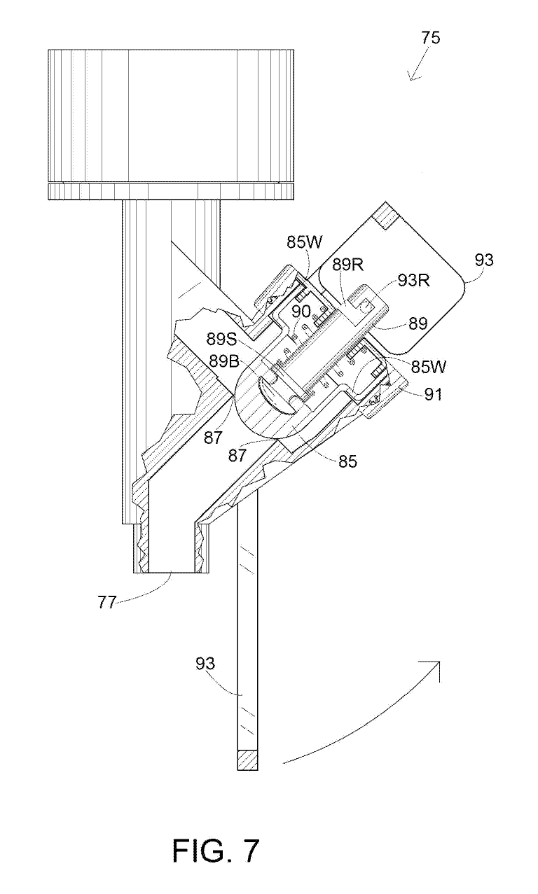

Referring to FIG. 7, the valve activation lever 93 of the dispenser valve 75 may be depicted in a resting position. When the valve activation lever 93 is resting, the seat cup 85 may be urged against the sealing seat 87, which may halt the flow of liquid from the reservoir 81 from making its way through the outlet port 77. The coil spring 90 may push up against the component compartment bonnet 91 and the spring base 89S of the peg 89. With the seat cup 85 attached to the peg base 89B, the seat cup 85 may be urged against sealing seat 87 which may halt the flow of liquid through the dispenser valve 75. Thus seat cup wall 85W may be in a straight position. The right pin slot 89R can be where a right pin 93R of the valve activation lever 93 engages with the peg 89.

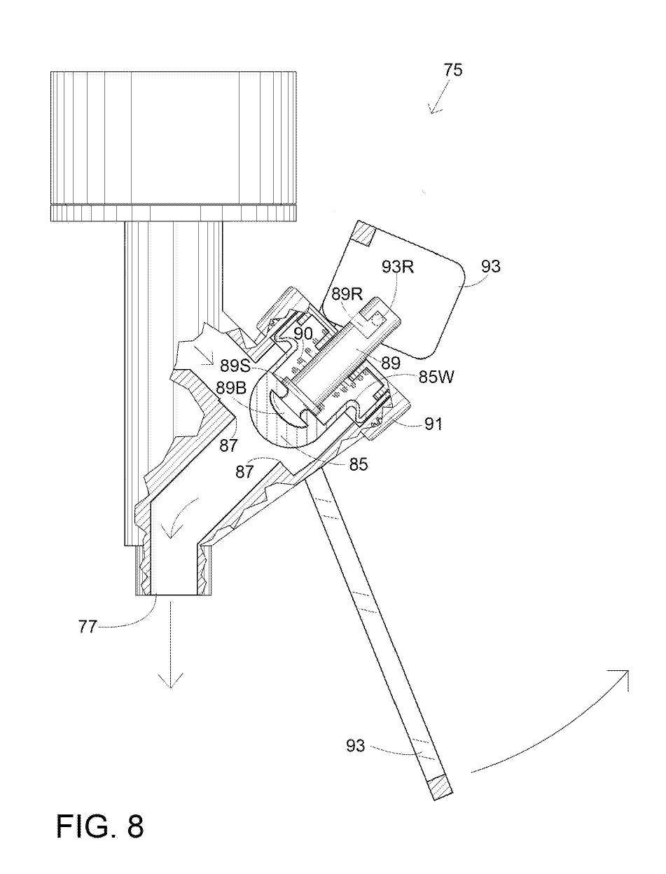

Referring to FIG. 8, the valve activation lever 93 of the dispenser valve 75 may be moved forward. When the valve activation lever 93 is activated, the right pin 93R and a left pin 93L (see FIG. 10), of the valve activation lever 93, that are inserted into the right pin slot 89R and a left pin slot 89L (see FIG. 10) of peg 89, may pull the peg base 89B of the peg 89 upward. When the peg 89 moves upward, it may pull the seat cup 85 away from the sealing seat 87 by compressing the coil spring 90 up against the coiled spring base 89S of the peg 89 and the component compartment bonnet 91. The liquid may then flow through the dispenser valve 75 from the reservoir 81 and may pass through the outlet port 77. Thus, the seat cup wall 85W may be in a flexed position.

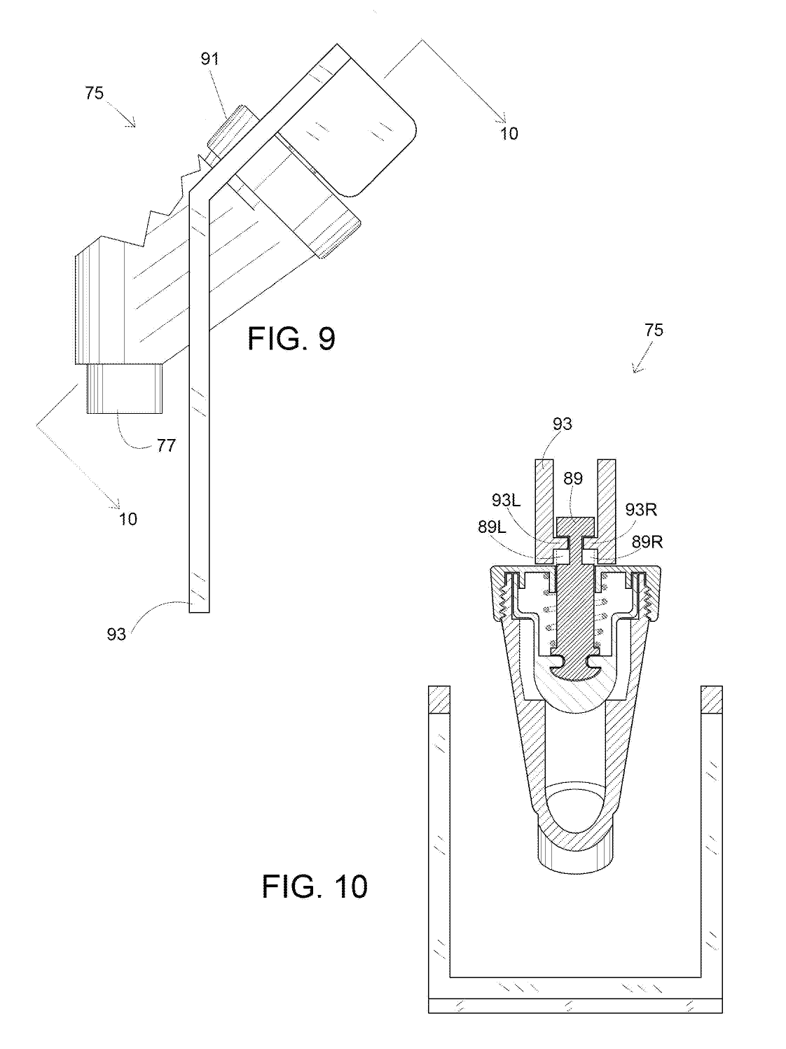

Referring to FIG. 9, the component compartment bonnet 91, the valve activation lever 93, and the outlet port 77 of dispenser valve 75 may be shown. In FIG. 10, which is a sectional view of FIG. 9 taken at the sectioning plane in the direction indicated by section lines 10-10, the right and left pins 93R and 93L of the valve activation lever 93 may be seen along with the right and left pin slots 89R and 89L of the peg 89, showing how the valve activation lever 93 may engage the peg 89 and may activate dispenser valve in 75.

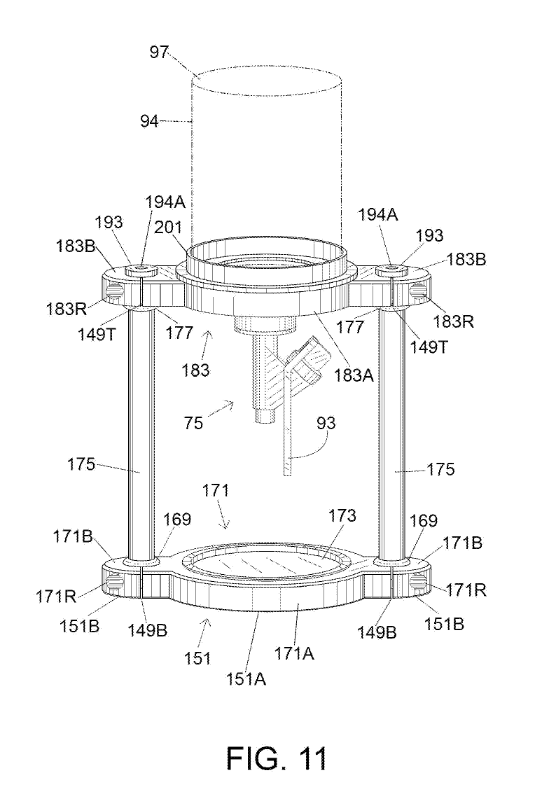

In FIG. 11, a perspective front and rear view of the dispenser may be seen. Looking at FIG. 11, a footpad section 151A and footpad section 151B of a footpad assembly 151 may bee seen. Footpad sections 151A and 151B may be a “self-adhesive” pad type that attach to a surface once the “peel off” paper backing has been removed, and may be attached to a foot section 171A and a foot section 171B of a base foot 171. A receiving disc 173 may be adapted to contain any liquid spilled from a vessel (not shown) or the valve 75, and may be partially inserted into the center of the base foot 171. A foot right bolt cavity 171R of the base foot 171 may be seen. A support member 175 may be seen attached to the base foot 171 and may extend upwards therefrom. A bottom flange 169 of a support member 175 may be seen. Near the top of the support member 175 may be a top flange 177. Top flange 177 may support a rim section 183A and a rim section 183B of a rim 183 to fixed vertical elevation. A rim right bolt cavity 183R of rim 183 may be seen. The rim 183 may be seen attached to the support members 175 and may be located above the base foot 171. A bushing 193 may be seen positioned at the top of rim 183. The bushing 193 may contain an engagement port 194A. Engagement port 194A may be where a fixture stem (shown later) may engage with the dispenser. A bottle collar 201 may be removably engaged into the rim 183. A division point 149B may be the point where the foot section 171A and foot sections 171B converge after assembly. A division point 149T may the point where rim the section 183A and the rim sections 183B converge after assembly. The vent hole 97 in the supply bottle 94 is may be seen. The supply bottle 94 may be removably engaged, inverted and positioned into bottle collar 201, and may be coupled to dispenser valve 75. A valve activation lever 93 of dispenser valve 75 may be seen in the present embodiment.

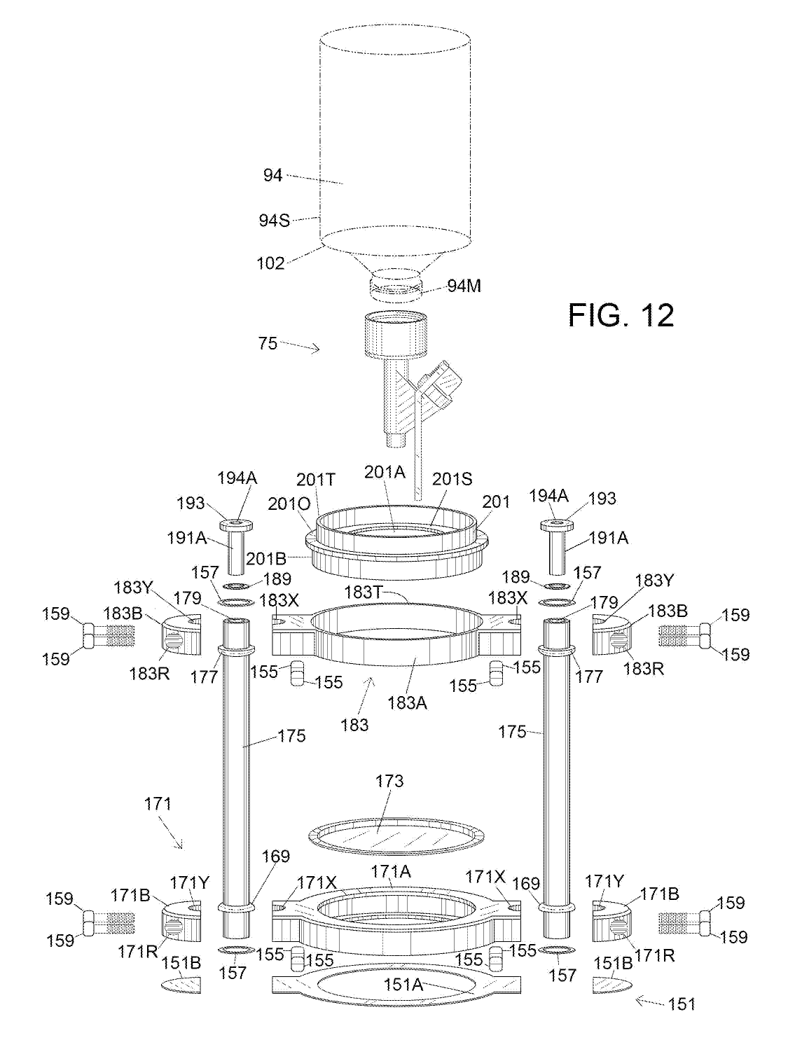

FIG. 12. Illustrates an exploded view of FIG. 11. Referring to FIG. 12, footpad section 151A and footpad sections 151B of footpad 151, may attach to foot section 171A and foot sections 171B of the base foot 171. The footpad 151 may protect the surface of a desktop, tabletop, countertop, etc., where the dispenser may be placed. The receiving disc 173 may be adapted to partially insert into the center of the base foot 171. The right nut and bolt cavities 171R of the base foot 171 may be two of four foot nut and bolt cavities (see 171R and a 171L of FIG. 15) of the base foot 171, where a bolt 159 may be installed to secure support members 175 between a clamping point 171X and a clamping point 171Y of the base foot 171. Bolts 159 may enter foot section 171B through foot right bolt cavity 171R and foot left bolt cavity 171L, referring to FIG. 15. Bolt 159 may be secured into a nut 155 that may be inserted into right and left side foot nut and bolt cavities 171R and 171L, again referring to FIG. 15. The dividing of the base foot 171 into foot section 171A and foot sections 171B and the clamping of support members 175 between the sections is one illustrated example of how support member 175 could be attached to the base foot 171. However, there may be other ways/methods of attaching support member 175 to the base foot 171 other than in the illustrated example of FIG. 12. Moving up from the base foot 171 the bottom flange 169 of support member 175 may be presented with a protective spacer 157, which may protect the surface of the base foot 171 when the dispenser may be fully assembled. Bottom flange 169 may act as a stopper to ensure that support members 175 may be flush with the bottom of the base foot 171 when installed. Next, near the top of the support members 175, top flange 177 may be seen. Top flange 177 of the support members 175 may secure rim section 183A and rim sections 183B of rim 183 to a fixed vertical position onto the support members 175. Rim 183 may be sectioned into rim section 183A and rim sections 183B.

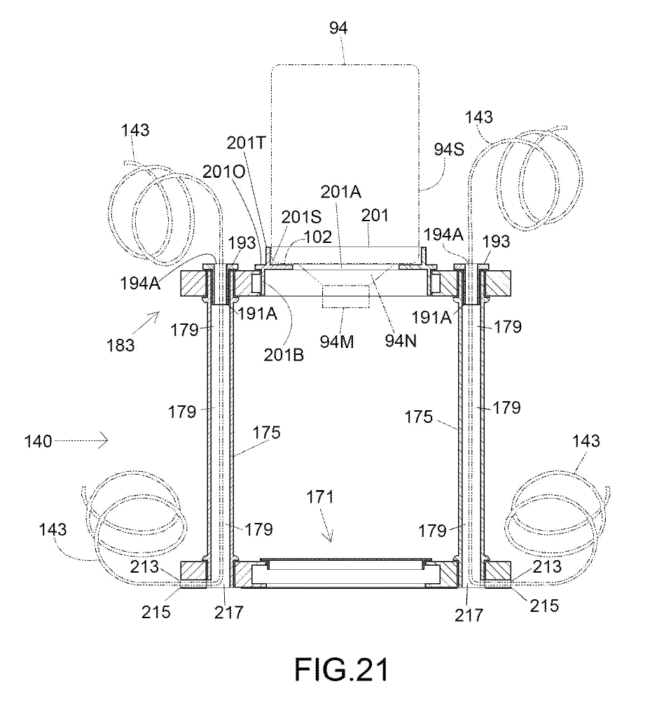

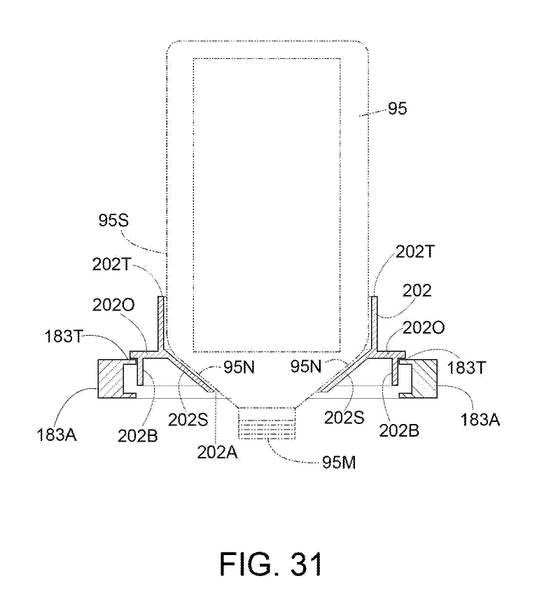

The dividing of rim 183 into rim section 183A and rim sections 183B and clamping the support members 175 between the two sections is one illustrated example of how support member 175 could be attached to rim 183. However, there may be other ways/methods of attaching the support members 175 to rim 183 other than in the illustrated example of FIG. 12. Rim Spacer 157 may be placed on top of a top flange 177, and may protect the bottom surface of rim 183. Right nut and bolt cavity 183R of rim sections 183B may be two of the four nut and bolt cavities, referring to 183R and a 183L of FIG. 16, where bolts 159 may be installed to secure support members 175 between a clamping point 183X and a clamping point 183Y. Bolts 159 may enter rim section 183B through right and left rim nut and bolt cavities 183R and 183L, again referring to FIG. 16. Bolts 159 may be secured into nuts 155 that fit into the right and left side rim nut and bolt cavities 183R and 183L of rim 183 referring to FIG. 16. Next up in FIG. 12 a spacer 189 may protect the surface of rim 183 from contact with bushing 193. An engagement leg 191A of bushing 193 may engage with a raceway 179 of support member 175. The center aperture in bushing 193 may be engagement port 194A that merges with a raceway 179 referring to FIG. 21. The engagement port 194A of bushing 193 may be the location where the fixture stem (not shown) engages with the raceway 179 of the support member 175. The rim 183 may removably engage the bottle collar 201, and the bottle collar 201 may removably engage the supply bottle 94. A variety of bottle collars that removably engage different supply bottles can be used with rim 183. For example, a bottle collar 202 and a bottle 95, referring to FIG. 31 may be used with the rim 183. A bottom ring 201B of bottle collar 201 may restrict a lateral movement of bottle collar 201 upon rim 183. The dispenser valve 75 may be coupled to the mouth 94M of the supply bottle 94 and may extend through the center aperture 201A of the bottle collar 201. A bottle seat 201S of bottle collar 201 may removably engage the supply bottle 94 on a shoulder 102 thereof. The bottle collar top enclosure 201T may engage and surround a sidewall 94S of supply bottle 94. An outer portion 2010, of the bottle collar 201 may be removably engaged upon a rim top 183T of the rim 183.

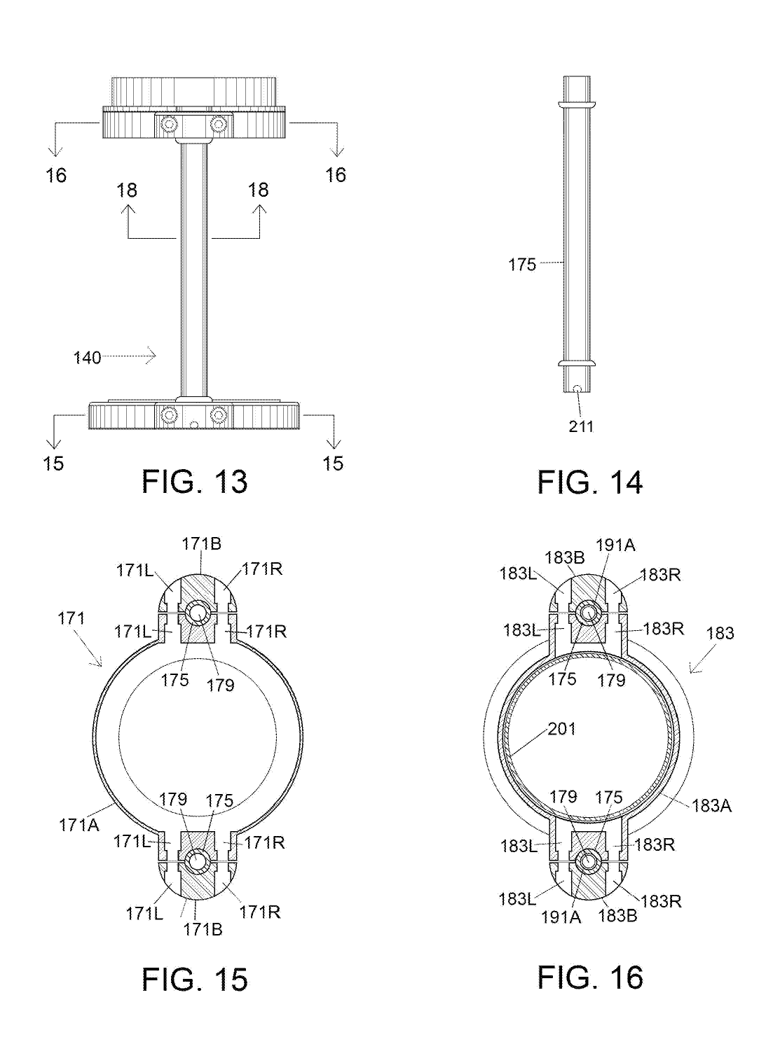

FIG. 13 may be a side view of the dispenser base 140.

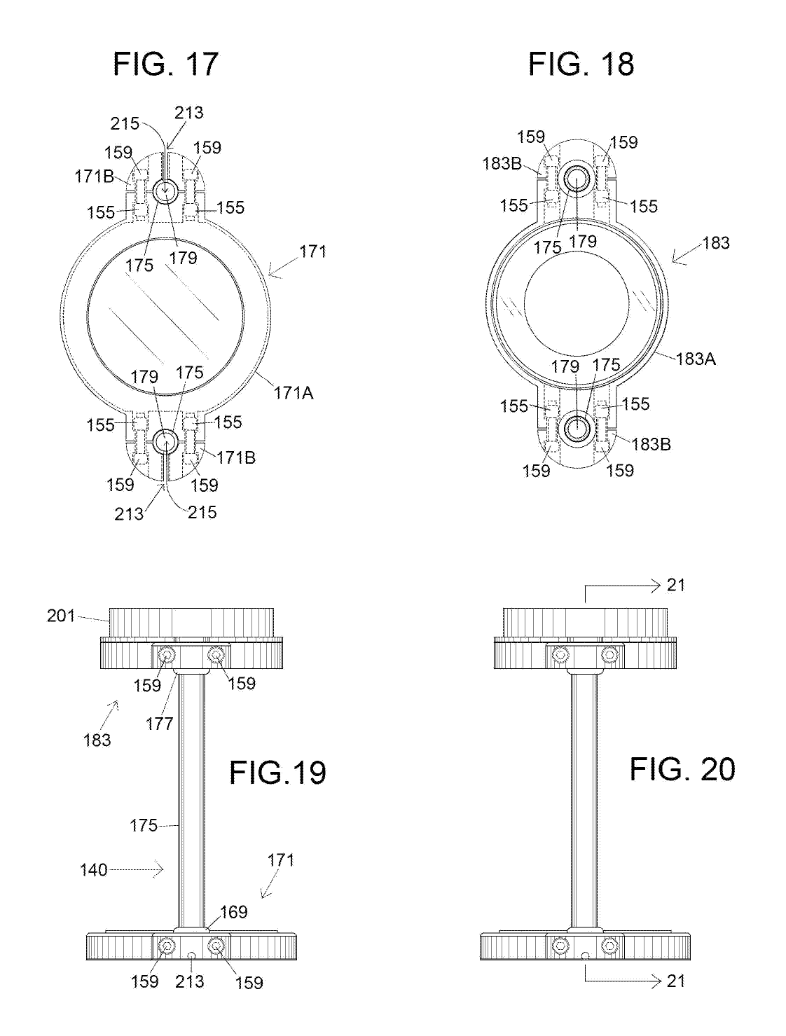

In FIG. 14 the backside of the support member 175 may be seen along with a support member aperture 211. The support member aperture 211 may be a niche in the support member 175 that may allow for the passage of an electric cord. In the FIG. 15 sectional view, the right and left side foot nut and bolt cavities 171R and 171L of the base foot 171 may be seen. The raceways 179 of the support members 175 may be where an electric cord 143 (FIG. 21), passes through the dispenser prior to entering into a fixture stem (shown later). Referring to the FIG. 16 sectional view, the right and left side rim nut and bolt cavities 183R and 183L of rim 183 may be viewed. The raceway 179 of the support members 175, and engagement leg 191A of bushing 193 (FIG. 12) may be seen. In the FIG. 17 bottom view, bolts 159 and bolt nuts 155 may be installed, and may lock foot section 171A and foot sections 171B securely into position against the support members 175. A base foot aperture 213 may be aligned with the support member aperture 211 of support member 175 (FIG. 14) to create a raceway 215. The raceway 215 may merge with a raceway 179 at an intersection 217 (FIG. 21), the raceway 179 then may head upward through the support members 175, and may merge with the engagement port 194A of the bushing 193.

The FIG. 18 sectional view may show the bolts 159 and the nuts 155 installed, and may lock the rim section 183A and rim sections 183B securely into position against the support members 175. The raceway 179 may merge with the raceway 215 (FIG. 17). Referring to FIG. 19 a side view of the dispenser base 140 may be seen. The bottle collar 201 may be engaged upon the rim 183. The bolts 159 may be secured into place into the base foot 171 and the rim 183. The top flanges 177 may be butted up against rim 183, and bottom flanges 169 may be butted up against the base foot 171. The base foot apertures 213 of the base foot 171 may lead to the support member aperture 211 of FIG. 14. The base foot aperture 213 may be the entrance to the raceway 215 of FIG. 17. The FIG. 20 illustration may be an orthogonal side view of dispenser base 140.

Referring to FIG. 21, a sectional view of dispenser base 140 may be seen. The circular top enclosure 201T of the bottle collar 201 may be formed to engage the circular body of the supply bottle 94. The circular top enclosure 201T may surround a portion of a sidewall 94S of the circular body of the supply bottle 94. The circular top enclosure 201T may be formed to restrict a lateral movement of the supply bottle 94 inverted and positioned therein. The bottle seat 201S of the bottle collar 201 may merge with the circular top enclosure 201T. The bottle seat 201S may be formed to removably engage the supply bottle 94 on a shoulder 102 thereof. The bottle seat 201S may have the center aperture 201A where an angled neck 94N and the mouth 94M of the supply bottle 94 may extend there through when the supply bottle is inverted and positioned thereon. The outer portion 2010 of the bottle collar 201 may merge with the bottle seat 201S and top enclosure 201T of the bottle collar 201. The outer portion 2010 of the bottle collar 201 may be formed to removably engage upon the rim top 183T of the rim 183. Thus the bottle collar 201 may be removably engaged upon rim 183. The bottom ring 201B may merge with the outer portion 2010 of the bottle collar 201. The bottom ring 201B may be positioned on the inside of the rim 183, and may be formed to restrict a lateral movement of the bottle collar 201 upon rim 183. The bottom ring 201B could also be formed on the outside of rim 183 to restrict the lateral movement of the bottle collar 201 upon rim 183. The raceways 179 of the dispenser base 140 may be viewed merging with the raceways 215 at the intersections 217. The electric cord 143 may enter at the base foot apertures 213, may pass through raceways 215, and may pass through the support member aperture 211 of FIG. 14. The electric cord 143 may then take a turn up at intersections 217, and may move into raceways 179 of the support members 175. Next, from the support members 175, the electric cord 143 may move into the engagement ports 194A, of the engagement legs 191A of the bushings 193.

The assembly and operation of the dispenser of FIG. 11 may now be discussed referring to the illustrations of FIGS. 11,12,14,17,18, and 21. The dispenser base 140 may be offered as an unassembled base 140, so it may be necessary to describe the assembly process. First of all, the footpad 151A may be attached to the foot section 171A, and the footpad's 151B may be attached to the foot sections 171B. The bolts 159 and the nuts 155, may be used to attach the foot section 171A to the foot sections 171B, as may be seen in FIG. 17. However, the bolts 159 may not be tightened into nuts 155 completely at this point as to allow for some slack between the foot section 171A and the foot sections 171B, so that the support members 175 may be installed. Next, the foot section 171A attached to the foot sections 171B may be placed in an upright position on a countertop. The protective spacers 189 may be installed onto the support members 175 at the electric cord aperture 211 end. Making sure that the support members 175 are upright with the electric aperture 211 at the bottom, the electric cord aperture 211 end of the support members 175 may be placed between the foot section 171A and the foot sections 171B. It should be noted sure that support member aperture 211 of FIG. 14 may be in alignment with the base foot aperture 213 of FIG. 20, to create raceway 215 of FIGS. 17, 21. Next, the bolts 159 may be tightened into the nuts 155 making sure the division point 149B of FIG. 11 finishes the same on the right and left side of the base foot 171. At this point, the protective spacers 157 may be installed onto the top of the support members 175.

Moving along, the rim section 183A may be attached to the rim sections 183B using the bolts 159 and the nuts 155 of FIG. 18. Again, the bolts 159 may not be tightened into the nuts 155 completely at this point as to allow for some slack between the rim section 183A and the rim sections 183B, so that the support members 175 may be installed. In the next step the rim section 183A attached to the rim sections 183B of the rim 183 may be placed over the support members 175 so that the support members 175 may lie between the rim section 183A and the rim sections 183B. At this point the rim 183 may be resting on the top flanges 177 of FIG. 12. The bolts 159 may now be tightened into the nuts 155 making sure the division point 149T FIG. 11 may finish the same on the right and left side of the rim 183. Next, the engagement legs 191A of the bushings 193 may be inserted through spacers 189. Now the engagement legs 191A of the bushing 193 may be inserted into the raceways 179 of the support members 175. Next, the bottle collar 201 may be engaged upon the rim 183. At this point the dispenser valve 75 may be coupled onto the supply bottle 94 of FIG. 11, and the supply bottle 94 may be inverted with the dispenser valve 75 attached, and inserted into the bottle collar 201. The vent hole 97 may now be administered into supply bottle 94. The dispenser may now be ready for service.

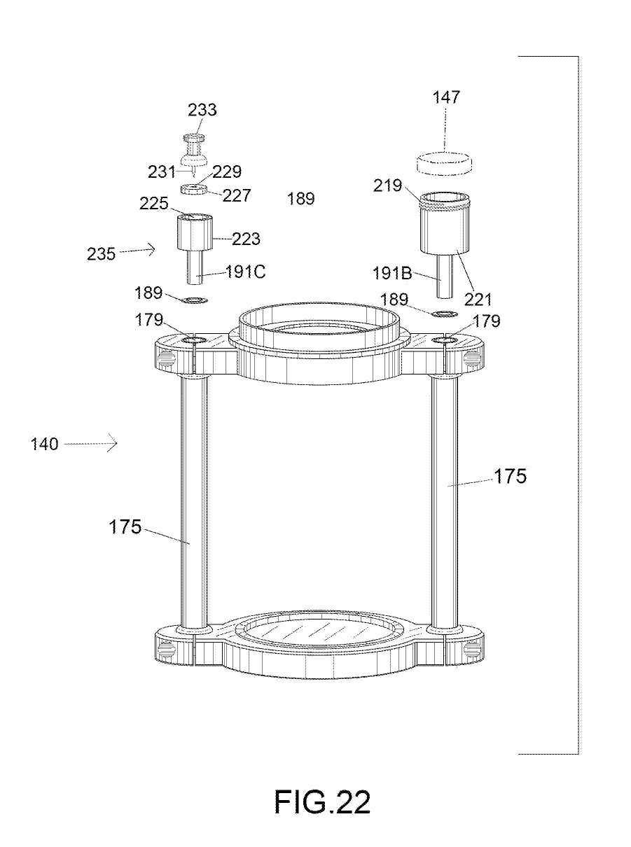

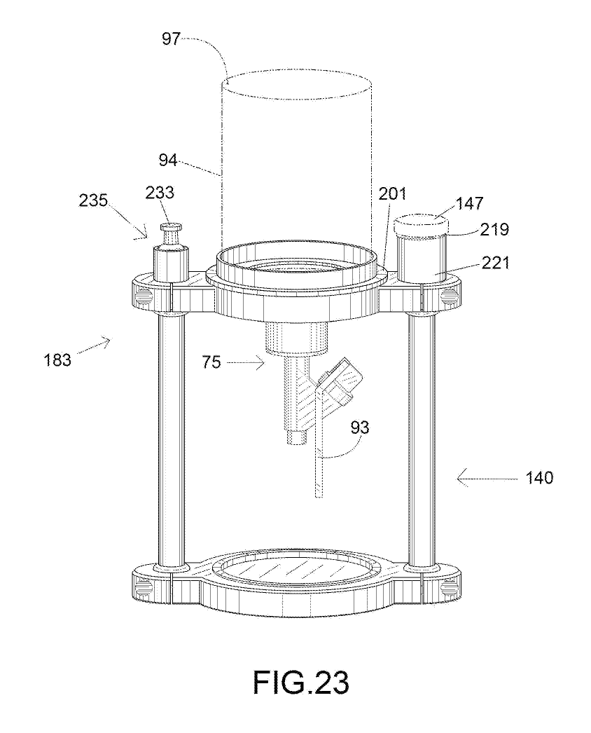

FIG. 22 may show an exploded view of the dispenser base 140 and a retaining device 221. The retaining device 221 may have a threaded cylinder 219. An engagement leg 191B of the retaining device 221 may be fitted with the spacer 189 and may be engaged and into the raceway 179 of the dispenser base 140. A bottle cap 147 that was removed from the supply bottle 94 of FIG. 23 may be threadably secured into place onto the threaded cylinder 219 of the retaining device 221.

Referring again to FIG. 22, an exploded view of a support device assembly 235 (hereinafter support device 235) and dispenser base 140 may be seen. The support device 235 may engage the dispenser base 140 with the engagement leg 191C extending therefrom. The piercing tool 233 may be used for administering the vent hole 97 in the supply bottle 94 (FIG. 23). The piercing tool 233 may be magnetically engaged to the support device 235. The spacer 189 may be placed onto the engagement leg 191C, and the engagement leg 191C of the support device 235 may be releasably engaged into the raceway 179 of the support member 175. A magnet cavity 225 may be located inside of the support cylinder 223, and is the location where a magnet 227 may releasably engage the piercing tool 233. A piercing tool spike 231 may enter through a magnet center hole 229. The magnet 227 may magnetically engage the piercing tool 233 to the support cylinder 223 of the support device 235. The piercing tool 233 may be partially or completely made of metal and may have a strong attraction to the magnet 227. Nevertheless, the piercing tool 233 may also rely solely on the metal of the piercing tool spike 231 for the magnetic attraction.

FIG. 23 may show a side view of the dispenser base 140 and the retaining device 221. The retaining device 221 may have the threaded cylinder 219. The threaded cylinder 219 may store a piercing tool 233 used for administering a vent hole in the supply bottle 94. The bottle cap 147 may be removed from the supply bottle 94 and may be threadably secured onto the threaded cylinder 219 of the retaining device 221 of the dispenser. The bottle cap 147 may be replaced with the dispenser valve 75. The supply bottle 94 may be removably engaged, and inverted and positioned within the bottle collar 201, and bottle collar 201 may be removably engaged upon the rim 183 of the dispenser base 140. A vessel (not shown) may be urged against the valve activation lever 93 of the dispenser valve 75 to extract the liquid from the supply bottle 94. It may be noted that having the threaded cylinder 219 to attach the bottle cap 147 thereto could be useful if a vented valve (not shown) were to be used with the dispenser. A vent hole 97 in the supply bottle 94 would not be necessary if a vented valve was to be used, and the supply bottle 94 could be turned upright prior to being emptied.

Referring again to FIG. 23, the support device 235 may be releasably engaged to the dispenser base 140, and the piercing tool 233 may be releasably engaged to the support device 235. Thus the piercing tool 233 may be releasably engaged to the dispenser base 140. The dispenser valve 75 may be coupled to supply bottle 94. The supply bottle 94 may be removably engaged within bottle collar 201, and bottle collar 201 may be removably engaged upon rim 183 of dispenser base 140. The piercing tool 233 may be used to administer a vent hole in the supply bottle 94. A vessel (not shown) may be urged against the valve activation lever 93 of dispenser valve 75, and the liquid may be dispensed from the supply bottle 94.

The operation of the dispenser having the retaining device 211 of FIG. 23 may now be discussed referring to the illustrations of FIGS. 22 and 23. First of all, the spacer 189 may be placed on the engagement leg 191B of the retaining device 221 of FIG. 22. Next, the retaining device 221 may be installed by inserting the engagement leg 191B into the raceway 179 of the dispenser base 140 of FIG. 22 so that the retaining device 221 may be engaged upon the dispenser base 140. The bottle cap 147 may now be removed from the supply bottle 94 and may be threadably secured onto the threaded cylinder 219 of the retaining device 221 of FIGS. 22 and 23. Now the dispenser valve 75 may be installed on to the supply bottle 94. The supply bottle 94 with the dispenser valve 75 attached may then be inverted, and dispenser valve 75 may be inserted through bottle collar 201 so that the supply bottle 94 is engaged within bottle collar 201. The dispenser may now be ready for service (FIG. 23).

The operation of the dispenser having the support device 235 of FIG. 23 may now be discussed referring to FIGS. 22 and 23. To begin with the spacer 189 may be placed on the engagement leg 191C of the support device 235 of FIG. 22. Next, the support device 235 may be installed on the dispenser base 140. The engagement leg 191C of the support device 235 may be inserted into the raceway 179 of the dispenser base 140 of FIG. 22. The support device 235 may now be engaged upon on the dispenser base 140. Next, the magnet 227 may be placed inside the support cavity 225 of the support cylinder 223. The piercing tool 233 may then be inserted into support cavity 225 of the support cylinder 223 with the piercing tool spike 231 entered through the magnet center hole 229 of magnet 227. Now the piercing tool 233 is secured upon the support device 235. Next, the bottle collar 201 may now be engaged upon rim 183, referring to FIG. 23. Next, the dispenser valve 75 of FIG. 22 may be installed onto the supply bottle 94, and the supply bottle 94 may be inverted with the dispenser valve 75 attached, and the supply bottle 94 may be inserted into bottle collar 201 of FIG. 23. At this point the supply bottle 94 may now be vented. The piercing tool 233 may be removed from the support device 235. Next, using the piercing tool spike 231 of the piercing tool 233 of FIG. 22, a vent hole 97 may be administered at the top of the inverted supply bottle 94. The piercing tool 233 may now be placed back onto the support device 235 of FIG. 23. The dispenser may now ready for service.

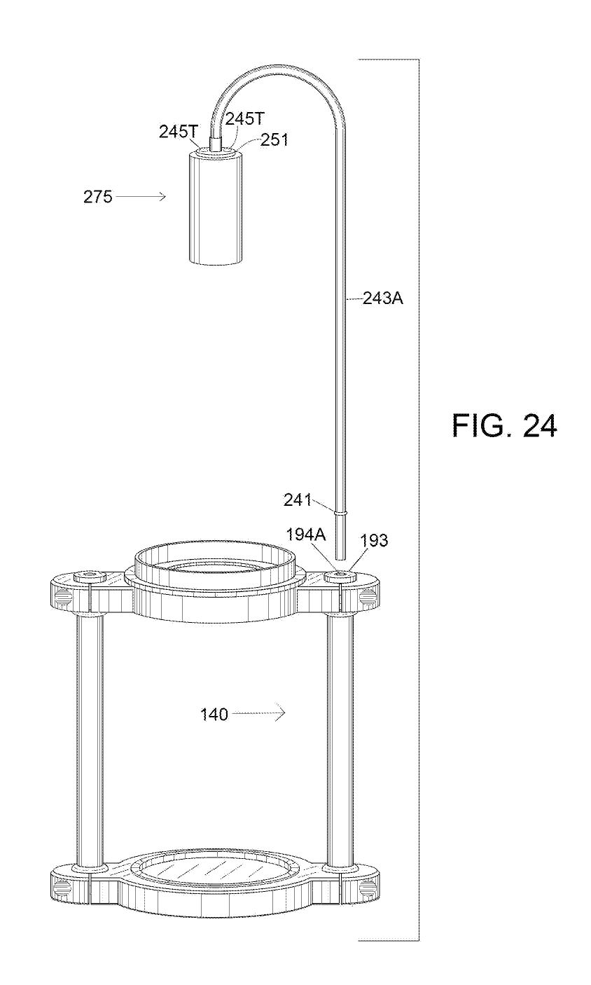

Referring to FIG. 24, an exploded view of a lamp fixture 275 attached to a fixture stem 243A, and the dispenser base 140 may be seen. The engagement port 194A of the bushing 193 may be where the fixture stem 243A engages with the base 140 and extends upwards therefrom. A fixture stem flange 241 of the fixture stem 243A may hold the lamp fixture 275 at a fixed vertical position to the bushing 193 of the base 140. A machine screw 245T, and a compression bracket 251 may be seen.

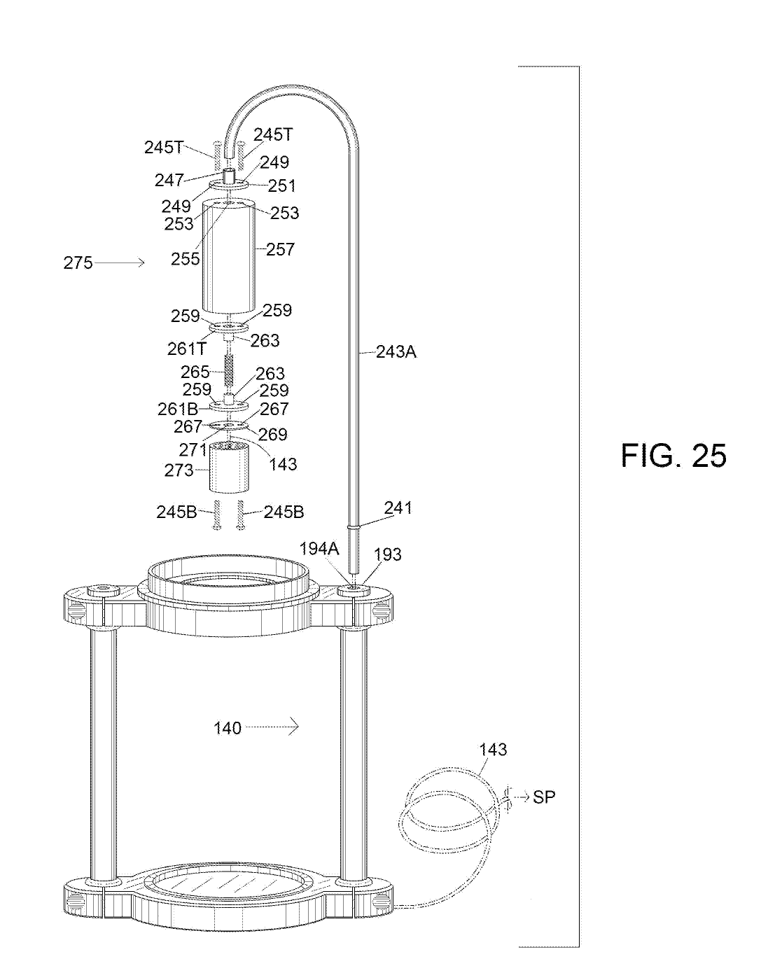

Referring to FIG. 25, an exploded view of the dispenser base 140, the fixture stem 243A, and the lamp fixture assembly 275 and may be seen. Looking at FIG. 25, the bushing 193 may be inserted into the dispenser base 140. The center hole in the bushing 193 may be the engagement port 194A that may merge with the raceway 179 of FIG. 21. The engagement port 194A may the location that the fixture stem 243A engages with the raceway 179 of the support member 175 of FIG. 12. Moving up, the fixture stem flange 241 may hold the fixture stem 243A at a secure vertical position when engaged with engagement port 194A of the bushing 193 of the base 140. A bracket compression cylinder 247 of a compression bracket 251 may be factory compressed onto the fixture stem 243A. The top machine screw 245T may enter a bracket hole 249 of the compression bracket 251. The screw 245T may pass through a lamp housing screw hole 253 of a lamp housing 257. Next, the screw 245T may then enter a threaded bracket hole 259 of a top bracket 261T. A bottom machine screw 245B may enter a standard light bulb socket 273. The screw 245B may pass through a spacer screw hole 267 of an insulating spacer 269. The screw 245B may then enter threaded screw hole 259 of a bottom bracket 261B. A threaded nipple 265 may be threadably secured into a cylinder bracket 263 of the top bracket 261T and the bracket threaded cylinder 263 of the bottom bracket 261B.

In communication with a remote power source indicated by SP, an electric cord 143 may pass through dispenser base 140, the bushing 193, and enter the fixture stem 243A. The electric cord 143 may then pass through the fixture stem 243A, and into the bracket compression cylinder 247, the compression bracket 251, a lamp housing hole 255, the threaded cylinder bracket 263 of the top bracket 261T, the threaded nipple 265, the threaded cylinder bracket 263 of the bottom bracket 261B, a spacer nipple hole 271 of the insulating spacer 269, and into the standard light bulb socket 273.

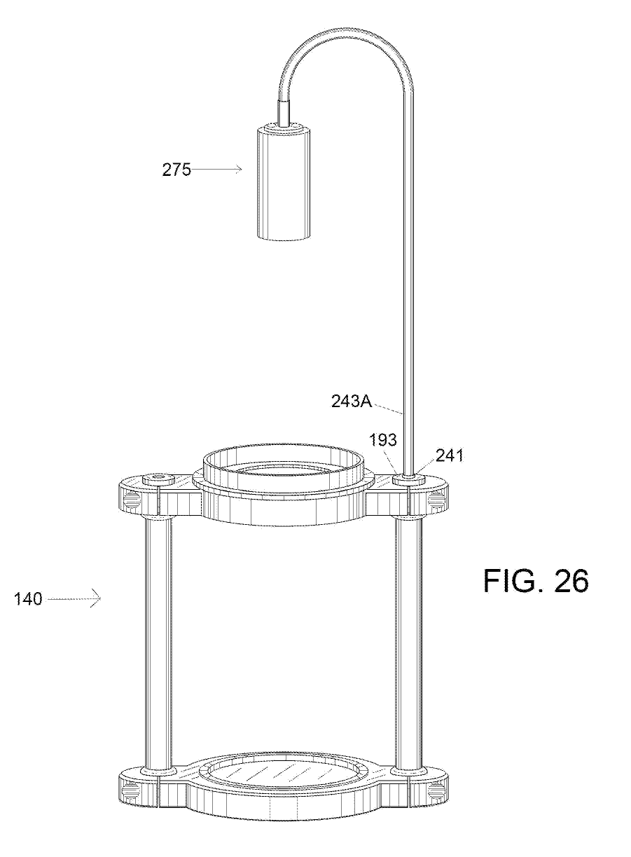

Referring to FIG. 26, the lamp fixture 275 may be seen attached to the fixture stem 243A. The fixture stem 243A may be seen engaging with the bushing 193 of the dispenser base 140 and extending upwards therefrom. The fixture stem flange 241 of the fixture stem 243A may be seen butted up against the bushing 193 of the dispenser base 140.

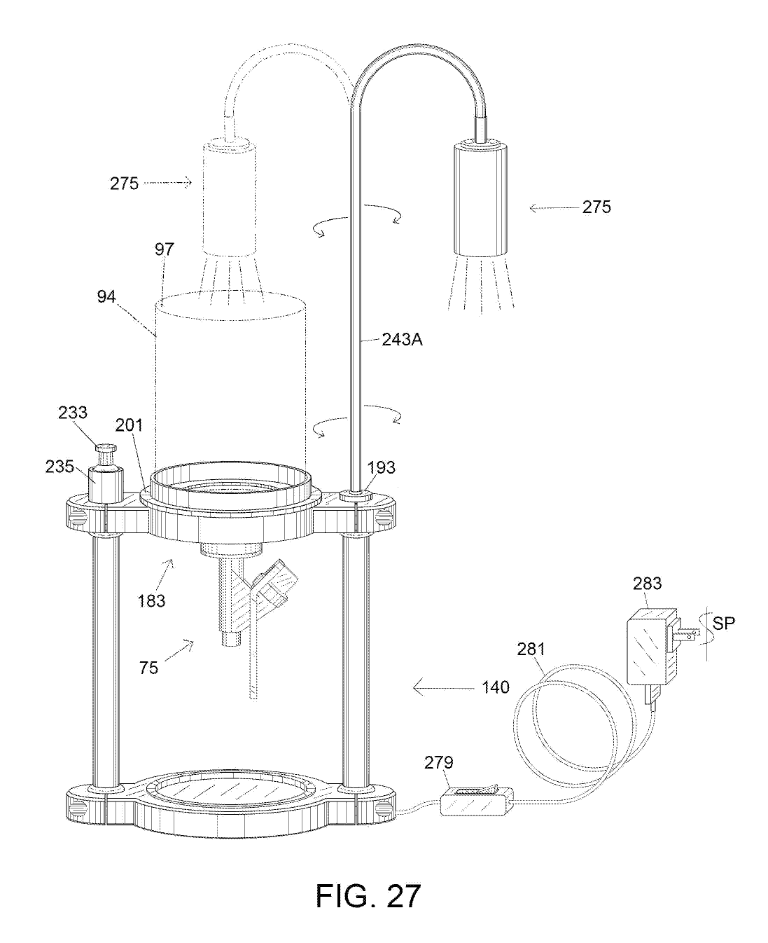

Referring to FIG. 27, the movement of the lamp fixture 275 from a position above the supply bottle 94, to a position to the right of the supply bottle 94 may be shown. The fixture stem 243A may be turned either clockwise or counter clockwise within the bushing 193. The lamp fixture 275 may be moved away from the supply bottle 94, so the supply bottle 94 may be removed when empty, and replaced. In FIG. 27 support device 235 may be engaged to the base 140. The vent hole 97 using the piercing tool 233 of the support device 235 may required for adequate flow of the liquid from the supply bottle 94 when the dispenser valve 75 may be used. The supply bottle 94 may be removably engaged in the bottle collar 201, and the bottle collar 201 may be removably engaged upon the rim 183 of the dispenser base 140. The remote power source SP may be indicated by AC adaptive power plug 283 in communication with the inline power switch 279 to the power conductive wire 281. The power conductive wire 281 in communication with the illumination source (not shown) of lamp fixture 275 as may be seen.

The operation of the dispenser base 140 having the lamp fixture 275 of FIG. 27 may now be discussed referring to FIGS. 24, 25 and 27. First of all, the dispenser may be placed on the top surface of a countertop, tabletop or desktop. Next, the fixture stem 243A may be rotated counterclockwise or clockwise enough so that the lamp fixture 275 may be away from the rim 183. At this point a light bulb (not shown) may be installed into the standard light bulb socket 273 (see FIG. 25) of lamp fixture 275. Now the bottle collar 201 may be removably engaged upon the rim 183. Moving along, the dispenser valve 75 may be threadably coupled onto an upright supply bottle 94 (upright illustration of the supply bottle 94 not shown). At this point, the supply bottle 94 may be installed into the bottle collar 201. The supply bottle 94 with the dispenser valve 75 attached, may be inverted, and lowered into position into the bottle collar 201 of FIG. 27. Now the fixture stem 243A may be rotated so that lamp fixture 275 is centered over the supply bottle 94. Next, the AC adaptive power plug 283 may be plugged into a power supply. Lastly, the vent hole 97 may be administered into the supply bottle 94 with the piercing tool 233. The dispenser may now be ready for service.

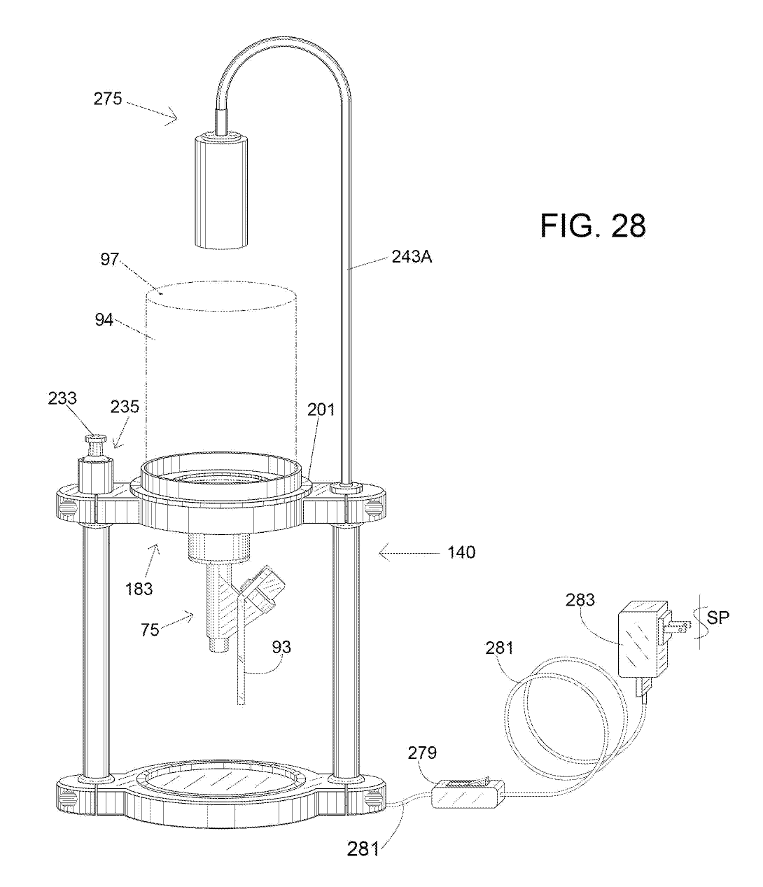

In FIG. 28 the base 140 may be engaged with the support device 235, the fixture stem 243A and the lamp fixture 275. The supply bottle 94 may be engaged within bottle collar 201, and bottle collar 201 may be removably engaged upon the rim 183 of the dispenser base 140. The piercing tool 233 of the support device 235 may be used to administer a vent hole 97 into the supply bottle 94. Upon the urging of a vessel (not shown) against the valve activation lever 93 of the dispenser valve 75, the liquid may be delivered from the supply bottle 94 into a vessel (not shown). The remote power source SP may be indicated by the AC adaptive power plug 283 in communication with the inline power switch 279 to the power conductive wire 281. The power conductive wire 281 in communication with the illumination source (not shown) of the lamp fixture 275 as may be seen. A standard incandescent light bulb (not shown) and wiring may be used with the dispenser as an illumination source in the lamp fixture 275. However, low voltage LED lighting and wiring may be a safer illumination source, and may also be used in lamp fixture 275. Additionally, a variety of hand held remote controlled low voltage multi-colored LED lamps may be available in the market today. Moreover, LED bulbs may burn much cooler than incandescent bulbs, thus may be less likely to raise the temperature of the liquid in the supply bottle 94 of FIG. 28. Also, the luminosity of LED bulbs may be adequate to illuminate the supply bottle 94 of FIG. 28. Lastly, USB cables may be used to connect the dispenser combined with the lamp fixture 275 directly into a USB computer port.

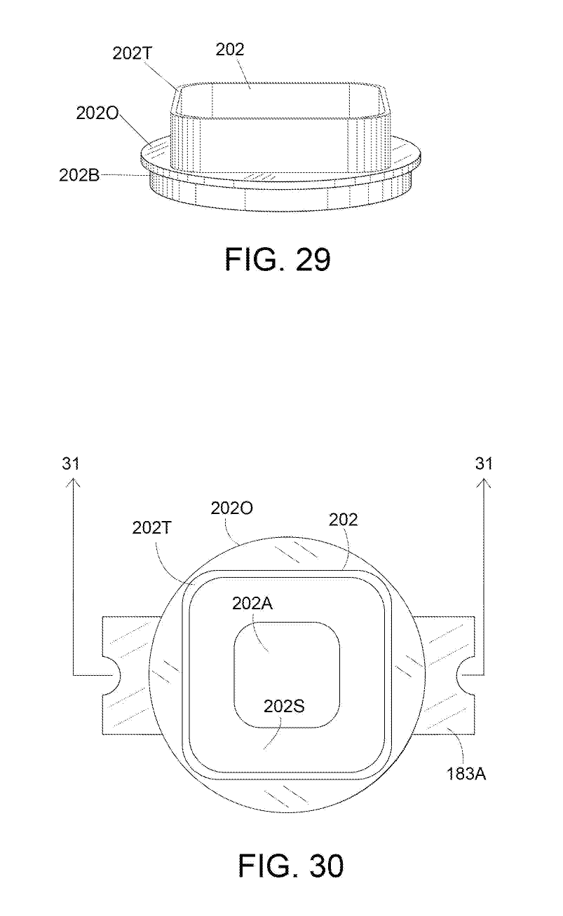

Referring to FIG. 29, a perspective view of another embodiment of a removable bottle collar, a removable bottle collar 202 (hereinafter bottle collar 202) may be seen. A rounded rectangular top enclosure 202T of the bottle collar 202 may be formed to engage a rounded rectangular body of an inverted water supply bottle 95 (hereinafter supply bottle 95) as shown in FIG. 31. The outer portion 2020, and a bottom ring 202B of bottle collar 202 may be seen.

Referring to FIG. 30, a top view of rounded rectangular top enclosure 202T, a bottle seat 202S, and a center aperture 202A of bottle collar 202 may be seen. An outer portion 2020 of bottle collar 202 may be removably engaged upon rim section 183A.

Referring to FIG. 31, a sectional view of FIG. 30 may be seen. The rounded rectangular top enclosure 202T of the bottle collar 202 may be formed to engage the rounded rectangular body of the supply bottle 95. The rounded rectangular top enclosure 202T may surround a portion of a sidewall 95S of the body of the supply bottle 95. The rounded rectangular top enclosure 202T may be formed to restrict a lateral movement of the supply bottle 95 inverted and positioned therein. The bottle seat 95S may merge with the top enclosure 202T. The bottle seat 95S may be formed to removably engage the supply bottle 95 on a portion of the angled neck 95N thereof. The angled neck 95N of supply bottle 95 begins at the shoulder 102 of the supply bottle 95. The bottle seat 202S may have the center aperture 202A where a mouth 95M of the supply bottle 95 may extend there through into the base cavity 168 when the supply bottle 95 may be inverted and positioned thereon. The outer portion 2020 of the bottle collar 202 may merge with the bottle seat 202S and the rounded rectangular top enclosure 202T of bottle collar 202. The outer portion 2020 of bottle collar 202 may be formed to removably engage upon the rim top 183T of rim section 183A. Thus the bottle collar 202 may be removably engaged upon rim section 183A. The bottom ring 202B may merge with the outer portion 2020 of the bottle collar 202. The bottom ring 202B may be positioned on the inside of rim section 183A, and may be formed to restrict a lateral movement of the bottle collar 202 upon the rim section 183A. The bottom ring 202B could also be formed on the outside of the rim section 183A to restrict the lateral movement of the bottle collar 202 upon the rim section 183A. The sectional view of the bottle collar 202 could also represent a sectional view of a bottle collar formed for a bottle (not shown) with a circular body like the supply bottle of 94 FIG. 28, but having the angled neck 95N like the neck of supply bottle 95.

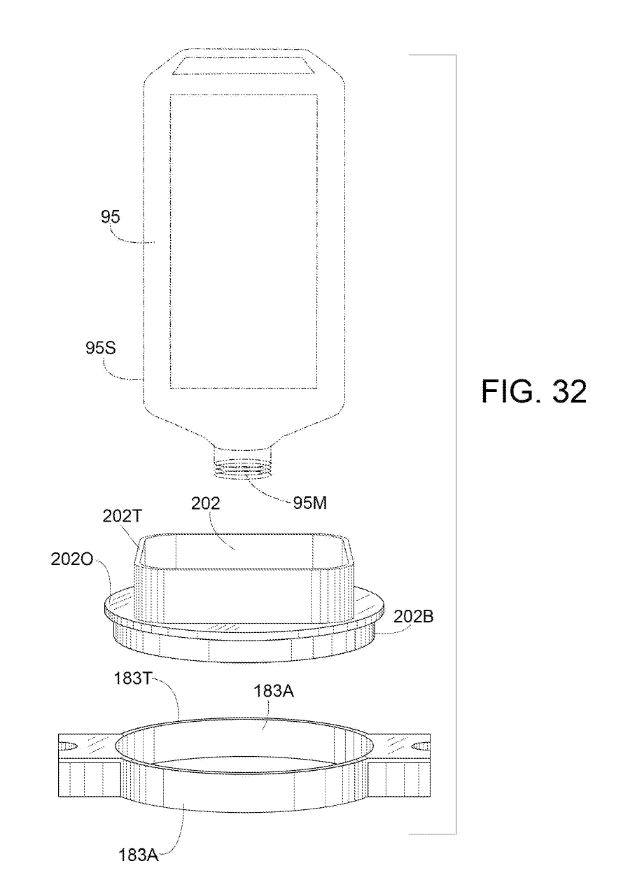

An exploded view of FIG. 31 and FIG. 33 may be seen in FIG. 32. Starting at the bottom of FIG. 32, one may see the rim section 183A, and the rim top 183T. Looking at the bottle collar 202, the outer portion 2020 of the bottle collar 202 may be seen. The outer portion 2020 of bottle collar 202 may be removably engaged upon the rim top 183T of the rim section 183A. The bottom ring 202B may restrict the lateral movement of bottle collar 202 while engaged upon rim top 183T of rim section 183A. The bottle collar 202 may engage and support the supply bottle 95 while inverted and positioned within the rim section 183A. The rounded rectangular top enclosure 202T may be formed to engage the supply bottle and restrict the lateral movement of the supply bottle inverted and positioned therein. A portion of the sidewall 95S of the body of the supply bottle 95 may be surrounded by the rounded rectangular top enclosure 202T. The bottle mouth 95M may be seen in the present embodiment.

Referring to FIG. 33, a perspective front view of the bottle 95, the bottle collar 202 and the rim section 183A may be seen. The bottle collar 202 may be seen removably engaged upon the rim section 183A. The bottle collar 202 may be adapted to engage and support the supply bottle 95 while the supply bottle 95 may be inverted and positioned within the rim section 183A. A portion of the sidewall 95S of the supply bottle 95 may be surrounded by the rounded rectangular top enclosure 202T. The outer portion 2020 of bottle collar 202 may be removably engaged upon the rim section 183A. The liquid (hereinafter water) from supply bottle 95 may be delivered from the mouth 95M of the supply bottle 95.

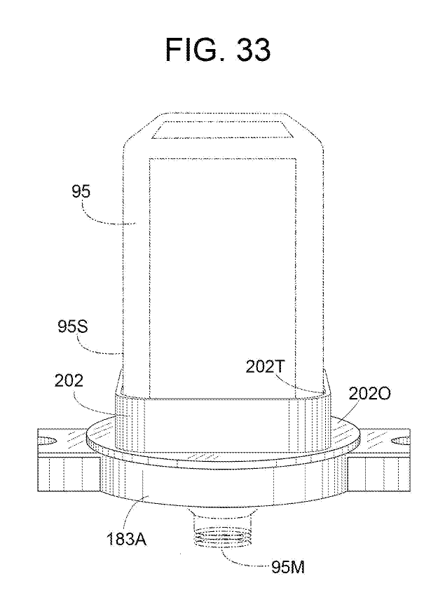

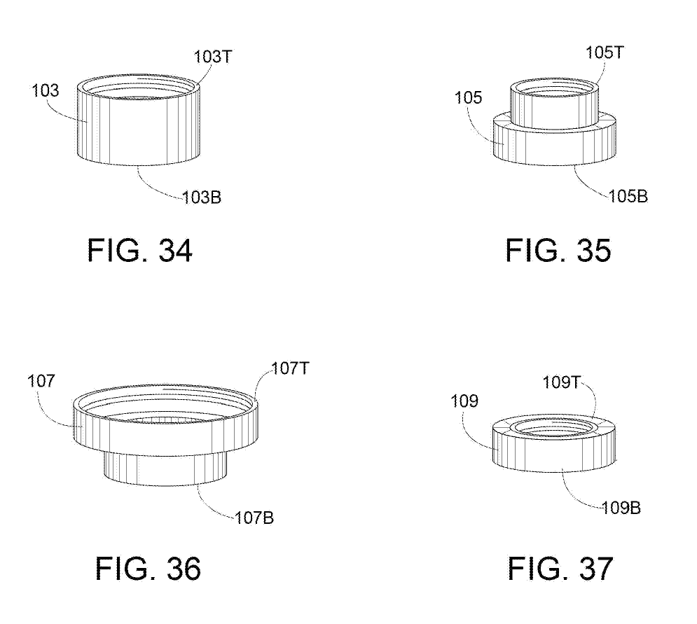

A perspective view of the bottle union 103 of FIG. 34 may now be discussed referring to FIG. 4. The bottle union 103 may have a union bottom 103B that may connect to the dispenser valve 75. Threads may be formed within an interior perimeter of the bottle union 103. The threads may be used to engage threads formed on the valve top 82 of the dispenser valve 75. A top 103T of the bottle union 103 may be formed so that the threads formed in the interior of the bottle union 103 engage with threads formed on a mouth 94M of the supply bottle 94.

In FIG. 35 a perspective view of another embodiment of a bottle union, a bottle union 105. The bottle union 105 can also be discussed referring to FIG. 4. The same functionality of bottle union 103 may apply to bottle union 105. However, in the embodiment of FIG. 45, a top diameter of a union top 105T may be smaller than a bottom diameter of a union bottom 105B. The union top 105T may be formed to fit the threaded mouth 94M of the supply bottle 94 in which the diameter of the specific bottle mouth may be smaller than the union bottom 105B that engages with the dispenser valve 75.

FIG. 36 may show a perspective view of another embodiment of a bottle union, a bottle union 107. Bottle union 107 can also be discussed referring to FIG. 4. The same functionality of bottle unions 103 and/or 105 may apply to the bottle union 107. However, in the embodiment of FIG. 36, a top diameter of a union top 107T may be larger than a bottom diameter of a union bottom 105B. The union top 107T may be formed to fit the threaded mouth of the supply bottle 94 in which the diameter of the specific bottle mouth may be larger than the union bottom 107B that may engage with dispenser valve 75 of FIG. 4.

One more embodiment of a bottle union, the bottle union 109 may be seen in FIG. 37. The FIG. 4 may also be used to discuss the bottle union 109. The bottle union 109 may locate the threads of a union top 109T that connect to a bottle mouth, within the diameter of the threads of a union bottom 109B that may connect with the threads of the valve top 82 of dispenser valve 75. The result may be a shorter, and more compact bottle union than the bottle union 105. However, if the bottle mouth 94M, and the threaded valve top 82 are of the same diameter as in FIG. 4, construction of the bottle union 109 may not be possible, and the bottle union 103 would probably be used. In addition, the bottle union 109 may also be used as a substitute for the bottle union 107 if flipped. If this were the case, the threaded valve top 82 may connect to the union top 109T and the bottle mouth 94M may connect to the union bottom 109B.

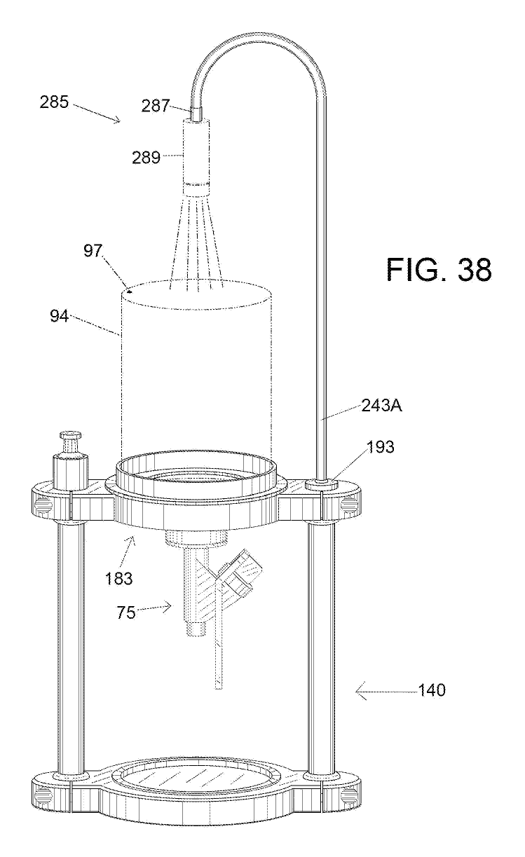

Referring to FIG. 38, the dispenser may be combined with an alternative lamp fixture 285. The fixture stem 243A may be seen engaging with the bushing 193 of the dispenser base 140 and extending upwards therefrom. A self-powered light 289 may be shown attached to the fixture stem 243A. A compression male adapter 287 may be attached to the fixture stem 243A. The self -powered light 289 may attach to the compression male adapter 287. The self-powered light 289 may be aimed downward to illuminate the supply bottle 94. The supply bottle 94 may be positioned within bottle collar 201, and the bottle collar 201 may be removably engaged upon rim 183 of the dispenser base 140. The dispenser valve 75 may be attached to the supply bottle 94. The vent hole 97 may be seen in the present embodiment.

The operation of the alternative lamp fixture 285 engaging with the dispenser base 140 of FIG. 38 may now be discussed referring to FIGS. 4, 27, and 38. First of all, the dispenser is placed on the top surface of a countertop, tabletop or desktop. Next the fixture stem 243A may be rotated counterclockwise or clockwise enough so that self-powered light 289 may be moved away from the rim 183 of FIG. 27 for rotation of the fixture stem 243A. Referring back to FIG. 38, the bottle collar 201 may be removably engaged upon the rim 183. Now the dispenser valve 75 may be threadably secured on the bottle mouth 94M (FIG. 4) of an upright supply bottle 94 (upright illustration of the supply bottle 94 not shown). Referring back to FIG. 38, at this point the supply bottle 94 may be inserted into the bottle collar 201. The supply bottle 94 with the dispenser valve 75 attached, may be inverted and lowered into position into the bottle collar 201 of the dispenser base 140. Now the fixture stem 243A may be rotated so that self-powered light 289 may be centered over the supply bottle 94. Next a vent hole 97 may be administered into the supply bottle 94. The dispenser may now be ready for service.

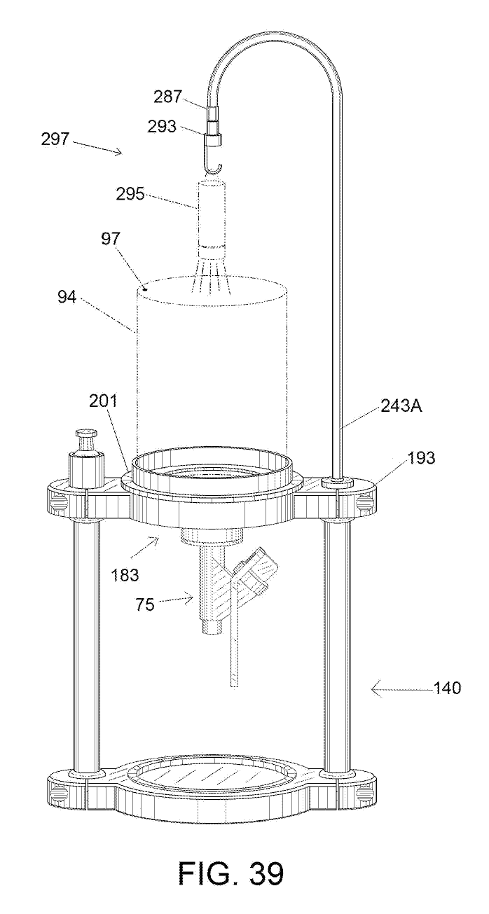

Referring to FIG. 39, the dispenser may be combined with an additional alternative lamp fixture 297. The fixture stem 243A may be seen engaging with the bushing 193 of the dispenser base 140 and extending upwards therefrom. A compression male adapter 287 may attach to the fixture stem 243A. A hook 293 may attach to the compression male adapter 287 of the fixture stem 243A. The hook 293 may be adapted to support a self-powered light 295 suspended therefrom. The self-powered light 295 may illuminate the supply bottle 94. The supply bottle 94 may be removably engaged within bottle collar 201, and bottle collar 201 may be removably engaged upon the rim 183 of the dispenser base 140. The dispenser valve 75 may be coupled to the supply bottle 94. The vent hole 97 may be seen in the present embodiment.

The operation of the alternative lamp fixture 297 of FIG. 39 may now be discussed referring to FIGS. 4, 27 and 39. To begin with, the dispenser may be placed on the top surface of a countertop, tabletop or desktop. Next the fixture stem 243A may be rotated counterclockwise or clockwise enough so the hook 293 is moved away from the rim 183 as seen in FIG. 27. Referring back to FIG. 39, now the bottle collar 201 can be removably engaged upon the rim 183. Next the dispenser valve 75 can be threadably coupled onto the bottle mouth 94M (see FIG. 4) of an upright supply bottle 94 (upright illustration of the supply bottle 94 not shown). Referring back to FIG. 39, at this point the supply bottle 94 may be installed into the bottle collar 201. The supply bottle 94 with bottle dispenser valve 75 attached may be inverted and removably engaged into the bottle collar 201. Now fixture stem 243A may be turned so that the hook 293 may be centered over the middle of the supply bottle 94 as may be seen in FIG. 39. Finally a self-powered light 295 may be attached to the hook 293. Next, a vent hole 97 may be administered into the supply bottle 94. The dispenser may now be ready for service.

The dispenser of the present invention provides numerous advantages. The dispenser accommodates a variety of commercial water bottles that currently have no valve dispensers. The dispenser may use the dispenser valve 75. When attached to the supply bottle and the supply bottle is inverted, the dispenser valve 75 may remove water from the supply bottle. The dropped water level in the supply bottle may allow for a vent hole to be administered in the supply bottle without water escaping from the vent hole.

The dispenser valves 75 may be easily installed onto different water bottles. Once the dispenser valve 75 is installed, the supply bottle may be easily inserted into the dispenser base 140. The dispenser 140 may provide a retaining device 221 that may be attached to the dispenser base 140. The retaining device 221 may store a piercing tool 233. The piercing tool 233 may be readily available to administer a vent hole in the supply bottle used with dispenser base 140. Next, the bottle cap 147 of the supply bottle may be threadably secured to a threaded cylinder 219 of the retaining device 221. Thus the retaining device 221 may prevent the bottle cap 147 from becoming lost. Additionally the dispenser may provide another device, a support device 235 that may also support and retain the piercing tool 233 that is used for administering a vent hole in the supply bottle. The difference being that the piercing tool 233 may be magnetically engaged to the support device 235. The vent hole is needed in the supply bottle in order for water to flow adequately from the supply bottle if a non-vented valve is used. The retaining device 221 and the support device 235 may releasably engage with the dispenser base 140.

The dispenser generally requires no cleaning as water is dispensed directly from the single use water bottles. Spillage of water is generally unlikely from the mouth of the water bottle as the dispenser valve 75 may be installed prior to lifting of the water bottle, so the bottle wall generally will not push in and force water out of the mouth of the water bottle. Further water contamination of the bottled water is unlikely as the water is received through the dispenser valve 75. The dispenser may allow for smaller quantities of the 4 oz. to 24 oz. water bottles to be used since the dispenser may allow for more “gallon” or larger jugs to be used in households and may lead to an improvement in the environment.

While embodiments of the disclosure have been described in terms of various specific embodiments, those skilled in the art will recognize that the embodiments of the disclosure may be practiced with modifications within the spirit and scope of the claims. For example, other embodiments of valves/connectors may be used to dispense water from the water bottle. Different embodiments of piercing tools as well as different embodiments of supporting devices for piercing tools may be used. Also, there are numerous ways and methods in which the base foot and the rim could be mounted to the support members, additionally the base foot could take on additional shapes/sizes other than the shape of the dispenser base foot mentioned in the above description. The receiving disk in the base foot could be excluded form the base. Furthermore, the dispenser could be used with inverted beverage bottles in addition to inverted water bottles. Accordingly, the scope should be determined not by the specific embodiments illustrated, but by the appended claims and their legal equivalents.

What is claimed is:

1: A dispenser base for delivering a liquid from a supply bottle comprising:
a dispenser base foot;
a support member attached to the dispenser base foot and extending upwards therefrom;
a second support member attached to the dispenser base foot and extending upwards therefrom;
a rim for supporting the supply bottle inverted and positioned within the rim, the rim attached to the support members and located above the dispenser base foot;
a fixture stem engaged to the dispenser base and extending upwards therefrom;
a lamp fixture attached to the fixture stem;
an illumination source in the lamp fixture; and
a source of electrical power in communication with the illumination source.

2: The dispenser base of claim 1 comprising a support device engaging the dispenser base for supporting and securing a piercing tool thereto, wherein the piercing tool is used to administer a vent hole in the supply bottle.

3: The dispenser base of claim 1, comprising:
a retaining device having a threaded cylinder engaging the dispenser base for supporting and securing a piercing tool thereto, wherein a bottle cap removed from the supply bottle is threadably secured to the threaded cylinder.

4: The dispenser base of claim 1 comprising a bottle collar engaging with the rim and adapted to engage the supply bottle inverted and positioned within the rim, the bottle collar having a center aperture where a mouth of the supply bottle extends there through.

5: The dispenser base of claim 1 comprising:
a support device engaging the dispenser base for supporting and securing a piercing tool thereto, wherein the piercing tool is used to administer a vent hole in the supply bottle; and
a bottle collar engaging the rim and adapted to engage the supply bottle inverted and positioned within the rim, the bottle collar having a center aperture where a mouth of the supply bottle extends there through.

6: The dispenser base of claim 1 comprising:
a bottle collar engaging the rim and adapted to engage the supply bottle inverted and positioned within the rim, the bottle collar having a center aperture where a mouth of the supply bottle extends there through; and
a dispenser valve removably coupled to the mouth of the supply bottle and extending through the center aperture in the bottle collar, wherein the dispenser valve controls a flow of the liquid delivered from the supply bottle.

7: The dispenser base of claim 1 comprising:
a support device engaging the dispenser base for supporting and securing a piercing tool thereto, wherein the piercing tool is used to administer a vent hole in the supply bottle;
a bottle collar engaging the rim and adapted to engage the supply bottle inverted and positioned within the rim, the bottle collar having a center aperture where a mouth of the supply bottle extends there through; and
a dispenser valve removably coupled to the mouth of the supply bottle and extending through the center aperture in the bottle collar, wherein the dispenser valve controls a flow of the liquid delivered from the supply bottle.

8: A dispenser base for delivering a liquid from a supply bottle comprising:
a dispenser base foot;
a support member attached to the dispenser base foot and extending upwards therefrom;
a second support member attached to the dispenser base foot and extending upwards therefrom;
a rim for supporting the supply bottle inverted and positioned within the rim, the rim attached to the support members and located above the dispenser base foot; and
a support device engaging the dispenser base for supporting and securing a piercing tool thereto, wherein the piercing tool is used to administer a vent hole in the supply bottle.

9: The dispenser base of claim 8 comprising a bottle collar engaging with the rim and adapted to engage the supply bottle inverted and positioned within the rim, the bottle collar having a center aperture where a mouth of the supply bottle extends there through.

10: The dispenser base of claim 8 comprising:
a bottle collar engaging the rim and adapted to engage the supply bottle inverted and positioned within the rim, the bottle collar having a center aperture where a mouth of the supply bottle extends there through; and
a dispenser valve removably coupled to the mouth of the supply bottle and extending through the bottle collar, wherein the dispenser valve controls a flow of the liquid delivered from the supply bottle.

11: A dispenser base for delivering a liquid from a supply bottle comprising:
a dispenser base foot;
a support member attached to the dispenser base foot and extending upwards therefrom;
a second support member attached to the dispenser base foot and extending upwards therefrom;
a rim for supporting the supply bottle inverted and positioned within the rim, the rim attached to the support members and located above the dispenser base foot;
a bottle collar engaging with the rim and adapted to engage the supply bottle inverted and positioned within the rim, the bottle collar having a center aperture where a mouth of the supply bottle extends there through, the bottle collar comprising:
a top enclosure formed to engage the supply bottle, the top enclosure surrounding a portion of a sidewall of the supply bottle and restricting a lateral movement of the supply bottle inverted and positioned therein;
a bottle seat formed to removably engage the supply bottle, the bottle seat having the center aperture where the mouth of the supply bottle extends there through when the supply bottle is inverted and positioned thereon; and
an outer portion of the bottle collar formed to be removably engaged upon the dispenser base.

12: The dispenser base of claim 11 comprising a dispenser valve removably coupled to the mouth of the supply bottle and extending through the bottle collar, wherein the dispenser valve controls a flow of the liquid delivered from the supply bottle.

13: A bottle collar for use with a dispenser base, the dispenser base delivering a liquid from an inverted supply bottle and having a dispenser base foot, a support member and a rim, the bottle collar comprising:
a top enclosure surrounding a portion of a sidewall of the inverted supply bottle and restricting a lateral movement of the inverted supply bottle positioned therein;
a bottle seat merging with the top enclosure formed to removably engage the inverted supply bottle, the bottle seat having the center aperture where a mouth of the inverted supply bottle extends there through when the inverted supply bottle is positioned thereon;
an outer portion merging with the bottle seat formed to be removably engaged upon the rim of the dispenser base; and
a bottom ring merging with the outer portion formed to restrict a lateral movement of the bottle collar upon the rim of the dispenser base.
